(19) United States
(12) Patent Application Publication
(10) Pub. No.: US 2007/0203047 A1
(43) Pub. Date: Aug. 30, 2007

(54) Dishwasher Detergent

(75) Inventors: Ulrich Pegelow, Dusseldorf (DE); Maren Jekel, Willich (DE); Christian Nitsch, Dusseldorf (DE); Arnd Kessler, Monheim (DE)

Correspondence Address: CONNOLLY BOVE LODGE & HUTZ LLP, PO BOX 2207, WILMINGTON, DE, 19899-2207, US

(73) Assignee: Henkel KGaA, Dusseldorf (DE)

(21) Appl. No.: 10/587,988

(22) PCT Filed: Jan. 8, 2005
(86) PCT No.: PCT/EP05/00108

§ 371 Date: Mar. 5, 2007

(30) Foreign Application Priority Data
Feb. 4, 2004 (DE) 10 2004 005 344.8

(51) Int. Cl. C11D 17/08; C11D 17/06

(52) U.S. Cl. 510/421; 510/447; 510/475

(57) ABSTRACT

The invention relates to a solid dishwasher detergent which comprises a) 1 to 40 wt. % of a bleaching agent, b) 0.25 to 20 wt. % of non-ionic surfactants(s); and c) 0.01 to 10 wt. % of at least one polymer having a molar mass of 2000 gmol⁻¹ or more and having at least one positive charge. The detergent is characterized in that the weight ratio of component b) to component c) ranges between 25:1 and 100:1, preferably between 30:1 and 80:1, and specifically between 35:1 and 75:1. The inventive dishwasher detergent is characterized by an improved cleaning and rinsing power and improved processability and shelf life.

This application relates to detergent or cleansing agents. In particular, this application relates to polymer-containing and surfactant-containing detergents or cleansing agents.

Nowadays, more stringent standards are often posed for machine-washed crockery than for hand washed crockery. Accordingly, crockery totally cleaned of food residues is also not considered faultless if, after the automatic dishwashing, it still has whitish spots from hard water or other mineral salts that originate from dried-out water droplets because of the lack of wetting agents.

In order to obtain shining and spotless crockery, rinsing agents are therefore employed with success today. The addition of rinsing agents at the end of the washing program ensures that the water almost totally runs off the washed goods, such that the various surfaces are free of residues and immaculately spotless at the end of the washing program.

Automatic dishwashing of tableware in household dishwashers normally includes a prewash cycle, a main wash cycle and a rinse cycle, that are interrupted by intermediate wash cycles. For the majority of machines, the prewash cycle is selectable for heavily soiled crockery, however, it is only selected in exceptional cases by the user, such that in the majority of cases a main wash cycle, an intermediate wash cycle with clean water and a rinse cycle are carried out. The temperature of the main wash cycle varies between 40 and 65° C. depending on the machine type and program choice. In the rinse cycle, rinse agents that usually comprise non-ionic surfactants as the major constituent are added from a dosing tank into the machine. These rinse agents are in liquid form and are extensively described in the prior art. Their function is primarily to prevent lime deposits and coatings on the cleaned crockery. In addition to water and weakly foaming non-ionic surfactants, these rinse agents also frequently comprise hydrotropes, pH adjusters, such as citric acid, or deposition-inhibiting polymers.

From EP-B1 0 197 434 (Henkel), liquid rinse agents are known that comprise mixed ethers as the non-ionic surfactants. A plurality of different materials (glass, metal, silver, plastic, porcelain) is cleaned in the dishwasher. All these materials have to be provided with the best possible wetting in the rinsing cycle. Rinse formulations that only comprise mixed ethers as the surfactant components do not satisfy these requirements—or only to a limited extent—with the result that the rinsing or drying effect is unsatisfactory, particularly for plastic surfaces.

The reservoir in the dishwasher has to be regularly filled up with rinse agent, one filling being sufficient for 10 to 50 wash cycles, depending on the type of machine. Forgetting to fill up the tank particularly results in unsightly glasses due to lime deposits and coatings. Consequently, there exist several proposals in the prior art to solve this by integrating a rinse agent in the cleansing agent for automatic dishwashers. These proposals are linked to the presentation form of the compact molded body.

Thus, the European Patent application EP-A-0 851 024 (Unilever) describes two-layer cleansing agent tablets, whose first layer comprises peroxy bleaching agents, builders and enzymes, while the second layer comprises acidifiers and a continuous medium with a melting point between 55 and 70° C. as well as deposition inhibitors. The high-melting, continuous medium is intended to provide a delayed release of the acid(s) and deposition inhibitor(s) and realize a rinsing effect. Dishwasher detergents in powder form or surfactant-containing rinse systems are not mentioned in this publication.

The object of the present invention consists of the provision of bleaching agent-containing dishwasher detergents with a rinse function, which deliver at least the same results in regard to the application technological properties as standard rinse agents and which moreover yield additional performance advantages. In this regard, the novel dishwasher detergents should develop their cleansing and rinsing performance independently of the preparation form, in particular without the addition of high-melting additives. In addition, the novel dishwasher detergents should excel in their improved shelf life and processability in comparison with conventional agents.

It has now been discovered that above average cleansing and rinsing results are delivered by bleaching agent-containing cleansing agents that comprise non-ionic surfactants and polymers with positively charged monomer units as additional constituents, the non-ionic surfactants and the mentioned polymers being present in these agents in a defined weight ratio.

Accordingly, the subject matter of the present application is a solid dishwasher detergent comprising
(a) 1 to 40 wt. % bleaching agent,
(b) 0.25 to 20 wt. % non-ionic surfactant(s);
(c) 0.01 to 10 wt. % of at least one polymer with a molecular weight of 2000 gmol⁻¹ or greater that possesses at least one positive charge,

wherein the weight ratio of the component b) to component c) is between 25:1 and 100:1, preferably between 30:1 and 80:1 and particularly between 35:1 and 75:1.

A first important constituent of the inventive solid dishwasher detergent is the bleaching agent. Among the compounds, which serve as bleaches and liberate H₂O₂ in water, sodium percarbonate, sodium perborate tetrahydrate and sodium perborate monohydrate are of particular importance. Examples of further bleaching agents that may be used are peroxypyrophosphates, citrate perhydrates and H₂O₂-liberating peracidic salts or peracids, such as perbenzoates, peroxyphthalates, diperoxyazelaic acids, phthaloimino peracids or diperoxydodecanedioc acids. Inventive cleansing agents can also comprise bleaching agents from the group of the organic bleaching agents. Typical organic bleaching agents are the diacyl peroxides, such as e.g. dibenzoyl peroxide. Further typical organic bleaching agents are the peroxy acids, wherein the alkylperoxy acids and the arylperoxy acids may be named as examples. Preferred representatives that can be added are (a) peroxybenzoic acid and ring-substituted derivatives thereof, such as alkyl peroxybenzoic acids, but also peroxy-α-naphthoic acid and magnesium monoperphthalate, (b) aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamido peroxycaproic acid, N-nonenylamido peradipic acid and N-nonenylamido persuccinates and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyidiperoxybutane-1,4-dioic acid, N,N-terephthaloyl-di(6-aminopercaproic acid).

Chlorine- or bromine-releasing substances can also be incorporated as the bleaching agents into the inventive dispersions. Suitable chlorine- or bromine-releasing materials include, for example, heterocyclic N-bromamides and N-chloramides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethyl hydantoin, are also suitable.

In the context of the present application, a particularly preferred dishwasher detergent according to the invention comprises preferably 2.5 to 30 wt. %, particularly preferably 3.5 to 20 wt. % and particularly 5 to 15 wt. % bleaching agent, preferably sodium percarbonate.

The active oxygen content of the dishwasher detergents according to the invention, based on the total weight of the detergent, preferably ranges between 0.4 and 10 wt. %, particularly preferably between 0.5 and 8 wt. % and particularly between 0.6 and 5 wt. %. Particularly preferred processed solid detergents possess an active oxygen content above 0.3 wt. %, preferably above 0.7 wt. %, particularly preferably above 0.8 wt. % and particularly above 1.0 wt. %.

A second important constituent of the dishwasher detergent according to the invention is the non-ionic surfactant. As described previously, the inventive agents comprise between 0.25 and 20 wt. % non-ionic surfactant(s). However, in the context of the present application, preferred agents are those that comprise the non-ionic surfactant(s) in quantities between 0.5 to 15 wt. %, preferably from 1 to 12.5 wt. %, particularly preferably from 1.5 to 10 wt. % and particularly from 2 to 8 wt. %. Preferably however, the inventive agents comprise more than 2.0 wt. % non-ionic surfactant(s), particularly between 2.5 and 7 wt. %, particularly preferably between 3.0 and 6 wt. % and especially between 3.0 and 5.5 wt. %.

In the scope of the present application, all non-ionic surfactants known to the person skilled in the art may be used as the non-ionic surfactants, in so far as they are fundamentally suitable for mixing with bleaching agents. Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxoalcohol groups. Particularly preferred are, however, alcohol ethoxylates with linear groups from alcohols of natural origin with 12 to 18 carbon atoms, e.g. from coco-, palm-, tallow- or oleyl alcohol, and an average of 2 to 8 EO per mole alcohol. Exemplary preferred ethoxylated alcohols include C₁₂₋₁₄-alcohols with 3 EO or 4EO, C₉₋₁₁-alcohols with 7 EO, C₁₃₋₁₅— alcohols with 3 EO, 5 EO, 7 EO or 8 EO, C₁₂₋₁₈-alcohols with 3 EO, 5 EO or 7 EO and mixtures thereof, as well as mixtures of C₁₂₋₁₄-alcohols with 3 EO and C12-18-alcohols with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO.

Furthermore, as additional non-ionic surfactants, alkyl glycosides that satisfy the general Formula RO(G)ₓ can be added, where R means a primary linear or methyl-branched, particularly 2-methyl-branched, aliphatic group containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1.0 and 10, preferably between 1.2 and 1.4.

Another class of preferred non-ionic surfactants which may be used, either as the sole non-ionic surfactant or in combination with other non-ionic surfactants, are alkoxylated, preferably ethoxylated or ethoxylated and propoxylated fatty acid alkyl esters preferably containing 1 to 4 carbon atoms in the alkyl chain.

Non-ionic surfactants of the amine oxide type, for example N-cocoalkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Other suitable surfactants are polyhydroxyfatty acid amides corresponding to the Formula,

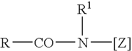

in which RCO stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to the Formula

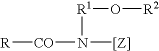

in which R is a linear or branched alkyl or alkenyl group containing 7 to 12 carbon atoms, R¹ is a linear, branched or cyclic alkyl group or an aryl group containing 2 to 8 carbon atoms and R² is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated derivatives of that group.

[Z] is preferably obtained by reductive amination of a reduced sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

The preferred surfactants are weakly foaming non-ionic surfactants. The inventive detergents for automatic dishwashers are especially preferred when they comprise non-ionic surfactants, particularly non-ionic surfactants from the group of alkoxylated alcohols. Preferred non-ionic surfactants are alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxoalcohol groups. Particularly preferred are, however, alcohol ethoxylates with linear groups from alcohols of natural origin with 12 to 18 carbon atoms, e.g. from coco-, palm-, tallow- or oleyl alcohol, and an average of 2 to 8 EO per mole alcohol. Exemplary preferred ethoxylated alcohols include C₁₂₋₁₄-alcohols with 3 EO or 4EO, C₉₋₁₁-alcohols with 7 EO, C₁₃₋₁₅— alcohols with 3 EO, 5 EO, 7 EO or 8 EO, C₁₂₋₁₈-alcohols with 3 EO, 5 EO or 7 EO and mixtures thereof, as well as mixtures of C₁₂₋₁₄-alcohols with 3 EO and C₁₂₋₁₈-alcohols with 5 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO.

In the scope of the present application, non-ionic surfactants from the group of alkoxylated alcohols, particularly preferably from the group of mixed alkoxylated alcohols and especially from the group of EO-AO-EO-non-ionic surfactants are incorporated with particular preference.

The inventive agents are especially preferred when they comprise a non-ionic surfactant that exhibits a melting point above room temperature. Accordingly, preferred dishwasher agents are characterized in that they comprise non-ionic surfactant(s) with a melting point above 20° C., preferably above 25° C., particularly preferably between 25 and 60° C. and, especially between 26.6 and 43.3° C.

Suitable non-ionic surfactants with a melting and/or softening point in the cited temperature range are, for example weakly foaming non-ionic surfactants that can be solid or highly viscous at room temperature. If non-ionic surfactants are used that are highly viscous at room temperature, they preferably have a viscosity above 20 Pas, particularly preferably above 35 Pas and especially above 40 Pas. Non-ionic surfactants that have a waxy consistency at room temperature are also preferred.

Preferred non-ionic surfactants that are solid at room temperature are used and belong to the groups of alkoxylated non-ionic surfactants, more particularly ethoxylated primary alcohols, and mixtures of these surfactants with structurally more complex surfactants, such as polyoxypropylene/polyoxyethylene/polyoxypropylene (PO/EO/PO) surfactants. Such (PO/EO/PO)-non-ionic surfactants are characterized in addition as having good foam control

In one preferred embodiment of the present invention, the non-ionic surfactant with a melting point above room temperature is an ethoxylated non-ionic surfactant that results from the reaction of a monohydroxyalkanol or alkylphenol containing 6 to 20 carbon atoms with preferably at least 12 moles, particularly preferably at least 15 moles and especially at least 20 moles of ethylene oxide per mole of alcohol or alkylphenol.

A particularly preferred non-ionic surfactant that is solid at room temperature is obtained from a straight-chain fatty alcohol containing 16 to 20 carbon atoms (C₁₆₋₂₀ alcohol), preferably a C₁₈ alcohol, and at least 12 moles, preferably at least 15 moles and more preferably at least 20 moles of ethylene oxide. Of these non-ionic surfactants, the so-called narrow range ethoxylates (see above) are particularly preferred.

Thus, particularly preferred dishwasher agents according to the invention comprise ethoxylated non-ionic surfactant(s) prepared from C₆₋₂₀-monohydroxy alkanols or C₆₋₂₀-alkyl phenols or C₁₆₋₂₀-fatty alcohols and more than 12 moles, preferably more than 15 moles and especially more than 20 moles ethylene oxide per mole alcohol.

Preferably, the room temperature solid non-ionic surfactant additionally has propylene oxide units in the molecule. These PO units preferably make up as much as 25% by weight, more preferably as much as 20% by weight and, especially up to 15% by weight of the total molecular weight of the non-ionic surfactant. Particularly preferred non-ionic surfactants are ethoxylated monohydroxyalkanols or alkylphenols, which have additional polyoxyethylene-polyoxypropylene block copolymer units. The alcohol or alkylphenol component of these non-ionic surfactant molecules preferably makes up more than 30 wt. %, more preferably more than 50 wt. % and most preferably more than 70 wt. % of the total molecular weight of these non-ionic surfactants. Preferred dishwasher agents are characterized in that they comprise ethoxylated and propoxylated non-ionic surfactants, in which the propylene oxide units in the molecule preferably make up as much as 25% by weight, more preferably as much as 20% by weight and, especially up to 15% by weight of the total molecular weight of the non-ionic surfactant.

Other particularly preferred non-ionic surfactants with melting points above room temperature contain 40 to 70% of a polyoxypropylene/polyoxyethylene/polyoxypropylene block polymer blend that contains 75% by weight of an inverted block copolymer of polyoxyethylene and polyoxypropylene with 17 moles of ethylene oxide and 44 moles of propylene oxide and 25% by weight of a block copolymer of polyoxyethylene and polyoxypropylene initiated with trimethylolpropane and containing 24 moles of ethylene oxide and 99 moles of propylene oxide per mole of trimethylolpropane.

Non-ionic surfactants, which may be used with particular advantage are obtainable, for example, under the name of Poly Tergent® SLF-18 from Olin Chemicals.

A further preferred inventive dishwasher agent comprises non-ionic surfactant(s) of Formula (I)
R¹O[CH₂CH(CH₃)O]ₓ[CH₂CH₂O]_{y}CH₂CH(OH)R², (1)

in which R¹ stands for a linear or branched aliphatic hydrocarbon group with 4 to 18 carbon atoms or mixtures thereof, R² means a linear or branched hydrocarbon group with 2 to 26 carbon atoms or mixtures thereof and x stands for values between 0.5 and 1.5 and y stands for a value of at least 15.

Other preferred non-ionic surfactants are the end capped poly(oxyalkylated) non-ionic surfactants corresponding to the following Formula
R¹O[CH₂CH(R³)O]ₓ[CH₂]ₖCH(OH)[CH₂]ⱼOR²

in which R¹ and R² stand for linear or branched, saturated or unsaturated, aliphatic or aromatic hydrocarbon groups with 1 to 30 carbon atoms, R³ stands for H or for a methyl, ethyl, n-propyl, isopropyl, n-butyl, 2-butyl or 2-methyl-2-butyl group, x stands for values between 1 and 30, k and j for values between 1 and 12, preferably 1 to 5. Each R³ in the above formula can be different for the case where x≧2. R¹ and R² are preferably linear or branched, saturated or unsaturated, aliphatic or aromatic hydrocarbon groups containing 6 to 22 carbon atoms, groups containing 8 to 18 carbon atoms being particularly preferred. H, —CH₃ or —CH₂CH₃ are particularly preferred for the group R³. Particularly preferred values for x are in the range from 1 to 20 and more particularly in the range from 6 to 15.

As described above, each R³ in the above formula can be different for the case where x≧2. By this means, the alkylene oxide unit in the straight brackets can be varied. If, for example, x has a value of 3, the substituent R³ may be selected to form ethylene oxide (R³═H) or propylene oxide (R³═CH₃) units which may be joined together in any order, for example (EO)(PO)(EO), (EO)(EO)(PO), (EO)(EO)(EO), (PO)(EO)(PO), (PO)(PO)(EO) and (PO)(PO)(PO). The value 3 for x was selected by way of example and may easily be larger, the range of variation increasing with increasing x-values and including, for example, a large number of (EO) groups combined with a small number of (PO) groups or vice versa.

Particularly preferred end-capped poly(oxyalkylated) alcohols corresponding to the above formula have values for both k and j of 1, so that the above formula can be simplified to
R¹O[CH₂CH(R³)O]ₓCH₂CH(OH)CH₂OR²

In this last formula, R¹, R² and R³ are as defined above and x stands for a number from 1 to 30, preferably from 1 to 20 and especially 6 to 18. Surfactants in which the substituents R¹ and R² have 9 to 14 carbon atoms, R³ stands for H and x takes a value of 6 to 15 are particularly preferred.

In summary, preferred dishwasher detergents according to the invention are those which comprise end capped poly(oxyalkylated) non-ionic surfactants corresponding to the formula
R¹O[CH₂CH(R³)O]ₓ[CH₂]ₖCH(OH)[CH₂]ⱼOR²
in which R¹ and R² stand for linear or branched, saturated or unsaturated, aliphatic or aromatic hydrocarbon groups with 1 to 30 carbon atoms, R³ stands for H or for a methyl, ethyl, n-propyl, isopropyl, n-butyl, 2-butyl or 2-methyl-2-butyl group, x has a value of 1 to 30, k and j have values of 1 to 12 and preferably 1 to 5, wherein surfactants of the type
R¹O[CH₂CH(R³)O]ₓCH₂CH(OH)CH₂OR²
in which x stands for numbers from 1 to 30, preferably 1 to 20 and especially 6 to 18, are particularly preferred.

Particularly preferred non-ionic surfactants in the context of the present invention have proved to be weakly foaming non-ionic surfactants, Which have alternating ethylene oxide and alkylene oxide units. Among these, the surfactants with EO-AO-EO-AO blocks are again preferred, wherein one to ten EO or AO groups respectively are linked together, before a block of the other groups follows. Inventive automatic dishwasher agents are preferred here, which comprise surfactants of the general formula (II) as the non-ionic surfactant(s)

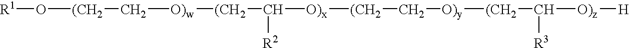

in which R¹ stands for a linear or branched, saturated or mono- or polyunsaturated C₆₋₂₄-alkyl or alkenyl group, each group R² or R³ independently of one another is selected from —CH₃, —CH₂CH₃, —CH₂CH₂—CH₃, CH(CH₃)₂, and the indices w, x, y, z independently of one another stand for whole numbers from 1 to 6.

The preferred non-ionic surfactants of Formula II can be manufactured by known methods from the corresponding alcohols R¹—OH and ethylene oxide or alkylene oxide. The group R¹ in the previous Formula II can vary depending on the origin of the alcohol. When natural sources are used, the group R¹ has an even number of carbon atoms and generally is not branched, the linear alcohols of natural origin with 12 to 18 carbon atoms, for example coconut, palm, tallow or oleyl alcohol being preferred. The alcohols available from synthetic sources are, for example Guerbet alcohols or mixtures of methyl branched in the 2-position or linear and methyl branched groups, as are typically present in oxo alcohols. Independently of the type of alcohol added for the manufacture of the non-ionic surfactants comprised in the agents, inventive automatic dishwasher agents are preferred, wherein R¹ in Formula II stands for an alkyl group with 6 to 24, preferably 8 to 20, particularly preferably 9 to 15 and particularly 9 to 11 carbon atoms.

In addition to propylene oxide, especially butylene oxide can be the alkylene oxide unit that alternates with the ethylene oxide unit in the preferred non-ionic surfactants. However, also other alkylene oxides are suitable, in which R² or R³ independently of one another are selected from —CH₂CH₂CH₃ or CH(CH₃)₂. Preferred automatic dishwasher agents are those wherein R² or R³ stand for a —CH₃ group, w and x independently of one another stand for values of 3 or 4 and y and z independently of one another stand for values of 1 or 2.

In summary, especially preferred inventive non-ionic surfactants for use in the agents according to the invention are those that have a C₉₋₁₅-alkyl group with 1 to 4 ethylene oxide units, followed by 1 to 4 propylene oxide units, followed by 1 to 4 ethylene oxide units, followed by 1 to 4 propylene oxide units. These surfactants exhibit the required low viscosity in aqueous solution and according to the invention are used with particular preference.

Other preferred non-ionic surfactants are the end-capped poly(oxyalkylated) non-ionic surfactants corresponding to the following Formula (III)
R¹O[CH₂CH(R³)O]ₓR² (III)
in which R¹ stands for linear or branched, saturated or unsaturated, aliphatic or aromatic hydrocarbon groups with 1 to 30 carbon atoms, R² for linear or branched, saturated or unsaturated, aliphatic or aromatic hydrocarbon groups with 1 to 30 carbon atoms, which preferably contains 1 to 5 hydroxyl groups and preferably is also functionalized with an ether group, R³ stands for H or for a methyl, ethyl, n-propyl, isopropyl, n-butyl, 2-butyl or 2-methyl-2-butyl group, x has a value between 1 and 40

Dishwasher detergents that comprise non-ionic surfactants of the general formula
R¹O[CH₂CH(R³)O]ₓR²
in which R¹ stands for linear or branched, saturated or unsaturated, aliphatic or aromatic hydrocarbon groups with 1 to 30 carbon atoms, R² for linear or branched, saturated or unsaturated, aliphatic or aromatic hydrocarbon groups with 1 to 30 carbon atoms, which preferably contains 1 to 5 hydroxyl groups and preferably is also functionalized with an ether group, R³ stands for H or for a methyl, ethyl, n-propyl, isopropyl, n-butyl, 2-butyl or 2-methyl-2-butyl group, and x has a value between 1 and 40, are also particularly preferred.

In particularly preferred non-ionic surfactants according to the above Formula (III), R³ stands for H. For the resulting end capped polyoxyalkylated non-ionic surfactants of Formula (IV)
R¹O[CH₂CH₂O]ₓR² (IV)
such non-ionic surfactants are particularly preferred, in which R¹ stands for linear or branched, saturated or unsaturated, aliphatic or aromatic hydrocarbon groups with 1 to 30 carbon atoms, preferably with 4 to 20 carbon atoms, R² for linear or branched, saturated or unsaturated, aliphatic or aromatic hydrocarbon groups with 1 to 30 carbon atoms, which preferably contains 1 to 5 hydroxyl groups and x has a value of 1 to 40

Particularly preferred end capped polyoxyalkylated non-ionic surfactants are those according to Formula (V)
R¹O[CH₂CH₂O]ₓCH₂CH(OH)R² (V)
which in addition to a group R¹ that stands for linear or branched, saturated or unsaturated, aliphatic or aromatic hydrocarbon groups with 1 to 30 carbon atoms, preferably 4 to 20 carbon atoms, comprises a linear or branched, saturated or unsaturated, aliphatic or aromatic hydrocarbon group with 1 to 30 carbon atoms R² that is neighboring an intermediate group —CH₂CH(OH)—. In this Formula, x stands for a number between 1 and 40.

In the scope of the present application, such dishwasher detergents are particularly preferred that comprise non-ionic surfactant(s) of the general formula
R¹O[CH₂CH₂O]ₓCH₂CH(OH)R²
which in addition to a group R¹ that stands for linear or branched, saturated or unsaturated, aliphatic or aromatic hydrocarbon groups with 1 to 30 carbon atoms, preferably 4 to 20 carbon atoms, additionally comprises a linear or branched, saturated or unsaturated, aliphatic or aromatic hydrocarbon group with 1 to 30 carbon atoms R² that is neighboring a monohydroxylated intermediate group —CH₂CH(OH)— and in which x stands for a number between 1 and 40.

The corresponding end capped polyoxyalkylated non-ionic surfactants of the previous formula can be obtained, for example, by treating a terminal epoxide of the formula R²CH(O)CH₂ with an ethoxylated alcohol of the formula
R¹O[CH₂CH₂O]ₓ₋₁CH₂CH₂OH

Further particularly preferred surfactants are those end capped polyoxyalkylated non-ionic surfactants of formula (VI)
R¹O[CH₂CH₂O]ₓ[CH₂CH(CH₃)O]_{y}CH₂CH(OH)R² (VI)
in which R¹ and R² independently of one another stand for linear or branched, saturated or mono- or polyunsaturated hydrocarbon groups with 2 to 26 carbon atoms, R³ independently of each other is selected from —CH₃, —CH₂CH₃, —CH₂CH₂—CH₃, CH(CH₃)₂, preferably —CH₃, however, and x and y independently of one another stand for values between 1 and 32, wherein surfactants with values for x from 15 to 32 and y from 0.5 and 1.5 are quite particularly preferred.

Preferred dishwasher detergent comprise a non-ionic surfactant(s) of the general formula 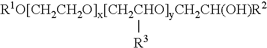
in which R¹ and R² independently of one another stand for linear or branched, saturated or mono- or polyunsaturated hydrocarbon groups with 2 to 26 carbon atoms and x and y independently of one another stand for values between 1 and 32, wherein surfactants with values for x from 15 to 32 and y from 0.5 and 1.5 are quite particularly preferred.

The cited carbon chain lengths and degrees of ethoxylation or alkoxylation of the abovementioned non-ionic surfactants constitute statistically average values that can be a whole or a fractional number for a specific product. Due to the manufacturing process, commercial products of the cited formulas do not consist in the main of one sole representative, but rather are a mixture, wherein not only the carbon chain lengths but also the degrees of ethoxylation or alkoxylation can be average values and thus be fractional numbers.

Of course, the dishwasher detergents according to the invention can comprise the abovementioned non-ionic surfactants not only as single substances, but also as surfactant mixtures of two, three, four or more surfactants. Accordingly, surfactant mixtures do not refer to mixtures of non-ionic surfactants that as a whole fall under one of the above cited general formulas, but rather refer to such mixtures that comprise two, three, four or more non-ionic surfactants that can be described by the different abovementioned general formulas.

If the dishwasher detergent according to the invention comprises two, three, four or more non-ionic surfactants, then the composition of the non-ionic surfactants comprised in the agent preferably lies within narrow limits. If a mixture of two non-ionic surfactants (surfactant 1 and surfactant 2) is employed, then the proportion by weight of the added non-ionic surfactants to one another (weight proportion of surfactant 1 to surfactant 2) is advantageously between 10:1 and 1:10, preferably 8:1 and 1:8, particularly preferably between 6:1 and 1:6 and particularly between 4:1 and 1:4.

If the dishwasher detergent according to the invention comprises two, three, four or more surfactants, then preferably at least one of the surfactants has a content by weight above 2.0 wt. %, advantageously above 3.0 wt. % and particularly above 4.0 wt. %.

The inventive agents comprise as the third important constituent 0.01 to 10 wt. % of at least one polymer having a molecular weight of 2000 gmol⁻¹ or above, which possesses a positive charge, dishwasher detergents being particularly preferred that comprise 0.02 to 7.5 wt. %, preferably 0.05 to 5 wt. %, particularly preferably 0.07 to 2.5 wt. % and particularly 0.1 to 1 wt. % of at least one polymer with a molecular weight of 2000 gmol⁻¹ or more, which possesses a positive charge.

In principle, the abovementioned polymers having a positive charge can concern cationic or amphoteric polymers. Preferred dishwasher detergents according to the invention are those wherein the polymer that possesses cationic monomer units concerns a cationic polymer and/or an amphoteric polymer.

In the context of the present invention, “cationic polymers” are polymers that carry a positive charge in the polymer molecule. These can be realized, for example, by (alkyl-) ammonium groups present in the polymer chain or other positively charged groups. Particularly preferred cationic polymers come from the groups of the quaternized cellulose derivatives, the polysiloxanes having quaternized groups, the cationic guar derivatives, the polymeric dimethyldiallylammonium salts and their copolymers with esters and amides of acrylic acid and methacrylic acid, the copolymers of vinyl pyrrolidone with quaternized derivatives of dialkylamino acrylate and -methacrylate, the vinyl pyrrolidone/methoimidazolinium chloride copolymers, the quaternized polyvinyl alcohols or the polymers listed under the INCI descriptions Polyquaternium 2, Polyquaternium 17, Polyquaternium 18 and Polyquaternium 27.

In the context of the present invention, “amphoteric polymers” are polymers that possess, in addition to a positively charged group in the polymer chain, further negatively charged groups or monomer units. These groups can concern, for example, carboxylic acids, sulfonic acids or phosphonic acids.

In the scope of the present application, dishwasher detergents are particularly preferred that comprise a polymer c) that possesses monomer units of the formula R¹R²C═CR³R⁴, in which each group R¹, R², R³, R⁴ independently of each other is selected from hydrogen, derivatized hydroxyl groups, C1 to C30 linear or branched alkyl groups, aryl, aryl substituted C₁₋₃₀ linear or branched alkyl groups, polyalkoxylated alkyl groups, heteroatomic organic groups having at least one positive charge without charged nitrogen, at least one quaternized nitrogen atom or at least one amino group with a positive charge in the pH range 2 to 11, or salts hereof, with the proviso that at least one group R¹, R², R³, R⁴ is a heteroatomic organic group with at least one positive charge without charged nitrogen, at least one quaternized nitrogen atom or at least one amino group with a positive charge.

In the scope of the present application, particularly preferred cationic or amphoteric polymers comprise a compound of the general Formula (VII) as the monomer unit. 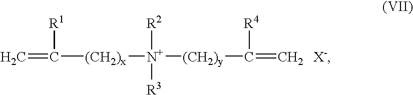
in which R¹ and R⁴ independently of one another stands for a linear or branched hydrocarbon group with 1 to 6 carbon atoms; R² and R³ independently of one another stand for an alkyl, hydroxyalkyl or aminoalkyl group, in which the alkyl group is linear or branched and has 1 to 6 carbon atoms, wherein it is preferably a methyl group; x and y independently of one another stand for whole numbers between 1 and 3. X represents a counter ion, preferably a counter ion from the group chloride, bromide, iodide, sulfate, hydrogen sulfate, methosulfate, lauryl sulfate, dodecylbenzene sulfonate, p-toluene sulfonate (tosylate), cumene sulfonate, xylene sulfonate, phosphate, citrate, formate, acetate or mixtures thereof.

Preferred groups R¹ and R⁴ in the above Formula (VII) are selected from —CH₃, —CH₂—CH₃, —CH₂—CH₂—C H₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

In the scope of the present application, quite particularly preferred polymers possess a cationic monomer unit of the general Formula (VII), in which R¹ and R⁴ stand for H, R² and R³ stand for methyl, and x and y are each 1. The monomer units corresponding to the formula
H₂C═CH—(CH₂)—N⁺(CH₃)₂—(CH₂)—C H═CH₂ x⁻
are also designated as DADMAC (diallyidimethylammonium chloride) for the case where X=chloride.

In the scope of the present application, further particularly preferred cationic or amphoteric polymers comprise a monomer unit of the general formula
R¹HC═CR²—C(O)—NH—(CH₂)ₓ—N⁺R³R⁴R⁵ X⁻ (VIII).
in which R¹, R², R³, R⁴ and R⁵ independently of one another stand for linear or branched, saturated or unsaturated alkyl, or hydroxyalkyl group with 1 to 6 carbon atoms, preferably for a linear or branched alkyl group selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, and x stands for a whole number between 1 and 6.

In the scope of the present application, quite particularly preferred polymers possess a cationic monomer unit of the general Formula (VIII), in which R¹ stands for H, and R², R³, R⁴ and R⁵ stand for methyl, and x stands for 3. The monomer units corresponding to the formula
H₂C═C(CH₃)—C(O)—NH—(CH₂)ₓ—N⁻(CH₃)₃ X⁻
are also designated as MAPTAC (methylacrylamidopropyl-trimethylammonium chloride) for the case where X⁻=chloride.

According to the invention, preferred dishwasher detergents are those wherein the polymer c) comprises diallyldimethylammonium salts and/or acrylamidopropyl-trimethylammonium salts as the monomer units.

The previously mentioned polymers possess not only cationic groups but also anionic groups or monomer units. These anionic monomer units come, for example, from the group of the linear or branched, saturated or unsaturated carboxylates, the linear or branched, saturated or unsaturated phosphonates, the linear or branched, saturated or unsaturated sulfates or the linear or branched, saturated or unsaturated sulfonates. Preferred monomer units are acrylic acid, the (meth)acrylic acids, the (dimethyl)acrylic acid, the (ethyl)acrylic acid, the cyanoacrylic acid, the vinylacetic acid, the allylacetic acid, the crotonic acid, the maleic acid, the fumaric acid, the cinnamic acid and its derivatives, the allylsulfonic acids, such as for example allyloxybenzene sulfonic acid and methallyl sulfonic acid or the allylphosphonic acids.

Preferred usable amphoteric polymers come from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkyl-aminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkyl methacrylate/alkylaminoethyl methacrylate/alkyl methacrylate copolymers as well as the copolymers of unsaturated carboxylic acids, cationic derivatized unsaturated carboxylic acids and optionally additional ionic or non-ionic monomers.

Preferred usable zwitterionic polymers come from the group of the acrylamidoalkyltrialkylammonium chloride/acrylic acid copolymers as well as their alkali- and ammonium salts the acrylamidoalkyltrialkylammonium chloride/methacrylic acid copolymers as well as their alkali- and ammonium salts and their methacroylethylbetain/methacrylate copolymers.

In addition, preferred amphoteric polymers are those that include methacrylamidoalkyl-trialkylammonium chloride and dimethyl(diallyl)ammonium chloride as the cationic monomer in addition to one or more anionic monomers.

Particularly preferred amphoteric polymers come from the group of methacrylamidoalkyl-trialkylammonium chloride/dimethyl(diallyl)ammonium chloride/acrylic acid copolymers, the methacrylamidoalkyltrialkylammonium chloride/dimethyl(diallyl)ammonium chloride/methacrylic acid copolymers and the methacrylamidoalkyltrialkylammonium chloride/dimethyl(diallyl)ammonium chloride/alkyl(meth)acrylic acid copolymers as well as their alkali- and ammonium salts.

In particular, preferred amphoteric polymers are from the group of the methacrylamidopropyltrimethylammonium chloride/dimethyl(diallyl)ammonium chloride/acrylic acid copolymers, the methacrylamidopropyltrimethylammonium chloride/dimethyl(diallyl)ammonium chloride/acrylic acid copolymers and the methacrylamidopropyltrimethylammonium chloride/dimethyl(diallyl)ammonium chloride/alkyl(meth)acrylic acid copolymers as well as their alkali- and ammonium salts.

In a particularly preferred embodiment of the present invention, the polymers with a molecular weight of 2000 gmol⁻¹ or above that are comprised in the inventive agents are present in preconditioned form. Suitable preconditioning of the polymers include
Encapsulation of the polymers by water-soluble or water-dispersible coating agents, preferably by water-soluble or water-dispersible natural or synthetic polymers;
Encapsulation of the polymers by water-insoluble, meltable coating agents, preferably by water-insoluble coating agents from the group of the waxes or paraffins having a melting point above 30° C.;
Cogranulation of the polymers with inert carriers, preferably with carriers from the group of detergent active or cleansing active substances, particularly preferably from the group of builders or cobuilders.

In a preferred dishwasher detergent the proportion by weight of the component b) to the component c) is between 25:1 and 100:1, preferably between 28:1 and 90:1, particularly preferably between 33:1 and 80:1 and especially between 35:1 and 70:1.

The inventive solid dishwasher detergents can be offered to the consumer in different preconditioned forms. In addition to the known powders, granules or extrudates, preferred dishwasher detergents in the scope of the present application are offered to the consumer in the form of preconditioned unit doses. The group of these preconditioned unit doses includes, for example, the mono or multiphase compacted solids (preferably mono or multi phase tablets), mono or multiphase castings, or filled, water-soluble or water-dispersible containers, preferably filled water-soluble or water-dispersible injection moldings, deep drawn objects or filled film pouches.

A further preferred embodiment of the present application relates to inventive dishwasher detergents in the form of a preconditioned unit dose, wherein said preconditioned unit dose concerns a molded body, preferably a multiphase molded body, in particular a multiphase tablet with a filled cavity.

In the scope of the present application, “deep drawn objects” are designated as those containers that are obtained by deep drawing an envelope material from a film. The “deep drawing” process in this context involves processes, in which a film of coating material, after being placed over a receiving cavity in a deep-drawing mold, is molded by the action of pressure and/or vacuum. The external coating material can be treated before or during the shaping by the action of heat and/or solvents and/or conditioning by relative humidities and/or temperatures, modified with respect to the surrounding conditions. The application of pressure can occur by means of two parts of a tool, which fit positively and negatively with each other and shape the film brought between these tools by pressing them together. The use of compressed air and/or the inherent weight of the film and/or the inherent weight of an active substance placed on the upper side of the film, is/are also suitable as pressure forces.

After the deep drawing, the deep-drawn external coating materials are preferably fixed in their deep-drawn shape by applying a vacuum inside the receiving cavity. The vacuum is preferably applied continuously from deep drawing to filling, preferably to sealing and particularly up to the separation from the receiving chamber. It is also possible to apply a discontinuous vacuum, for example up to the deep drawing of the receiving chambers and (after a pause) before and during the filling of the receiving chamber. The continuous or discontinuous vacuum can also vary in strength; for example at the beginning of the process (deep drawing of the film), higher values can be applied than at the end (filling or sealing or separation).

As already mentioned, the external coating material can be treated prior to or during the shaping into the receiving cavity of the mold by the action of heat. Thus the external coating material, preferably a water-soluble or water-dispersible polymer film, is heated for up to 5 seconds, advantageously for 0.1 to 4 seconds, particularly preferably for 0.2 to 3 seconds and in particular for 0.4 to 2 seconds to a temperature above 60° C., advantageously above 80° C., particularly preferably between 100 and 120° C. and particularly to temperatures between 105 and 115° C. To dissipate this heat, but particularly to also dissipate the heat brought into the receiving chamber by the deep drawn product (e.g. melts), it is preferred to cool the matrix and the receiving cavity in this matrix. They are advantageously cooled down to temperatures below 20° C., preferably below 15° C., particularly preferably to temperatures between 2 and 14° C. and particularly to temperatures between 4 and 12° C. Preferably, the cooling is continuous from the start of the deep drawing process to the sealing and separation from the receiving chamber. Liquid coolants are particularly suitable for cooling; preferably water, which is circulated inside the matrix by means of special cooling ducts.

This cooling, like the previously described, continuous or discontinuous application of a vacuum, has the advantage of preventing a shrink-back of the deep drawn containers, whereby not only the optical properties of the product are improved, but also the material, filled in the receiving chamber, is simultaneously prevented from escaping past the edge of the receiving chamber, e.g. into the sealing area of the chamber. Sealing problems with filled chambers are thus avoided.

The deep drawing process can be sub-divided into two methods, one in which the external coating material is fed horizontally in a mold and from there fed horizontally to filling and/or sealing and/or removal, and processes, in which the external coating material is fed over a continuously circulating matrix shaping roll (optionally with a counter-running stamping shaping roll, which leads the upper shaping stamps into the cavities of the matrices' shaping roll). The first mentioned process variant, the flatbed process, is carried out both continuously and discontinuously, the second process variant with the shaping rolls is usually continuous. All known deep drawing processes are suitable for manufacturing the preferred agents according to the invention. The receiving cavities in the matrices can be arranged “in line” or offset.

The deep drawn objects can have one, two, three or more chambers. These chambers in the deep drawn part can be arranged beside one another and/or above one another. In a preferred embodiment of the present application, the inventive dishwasher detergent is conditioned in a water-soluble or water-dispersible deep drawn object that also comprises a cleansing agent or mixture of cleansing agents in liquid or gel form, in addition to the inventive solid dishwasher detergent present in a separate chamber.

The water-soluble or water-dispersible containers can also be manufactured by injection molding as well as by deep drawing. Injection-molding means converting a molding material in such a way that material required for more than one injection cycle is heated in a barrel to soften it and is then introduced, under pressure, through a nozzle into the cavity of an already closed mold. The process is principally used for non-crosslinkable molding materials, which cool down in the mold and solidify. Injection molding is a very efficient modern process for manufacturing non-cut objects and is particularly suitable for automated mass-production. In practical operation, the thermoplastic molding materials (powder, pellets, diced forms, pastes, inter alia) are heated until liquid (to 180° C.) and injected under high pressure (up to 140 MPa) into a preferably water-cooled closed, two-piece mold, consisting of a cavity (earlier a matrix) and core (earlier stamp), where they cool and solidify. Plunger and screw injection molding machines are suitable. Water-soluble polymers, such as the abovementioned cellulose ethers, pectins, polyethylene glycols, polyvinyl alcohols, polyvinyl pyrrolidones, alginates, gelatines or starches are suitable molding materials (injection molding materials).

However, the external coating materials can also be cast into moldings. The molding of the resulting inventive preferred water-soluble or water-dispersible portioned agent includes at least one solidified melt. This melt can be a molten pure substance or a mixture of several substances. Naturally, it is possible to mix the individual substances before melting into a multi-substance melt, or to prepare separate melts, which are then combined. Melts of mixtures of substances can be advantageous, e.g. if eutectic mixtures form, which melt much lower and therefore reduce process costs.

In a preferred embodiment of the present invention, the exterior coating material cast into the molding includes at least partially an inventive detergent or cleansing agent. It is particularly preferred to manufacture cast moldings, which consist entirely of an inventive detergent or cleansing agent.

Dishwasher detergents in a preconditioned unit dose, wherein the preconditioned unit dose concerns a filled, water-soluble container, preferably a filled injection molded object, a filled casting or a filled film pouch are particularly preferred in the scope of the present application.

The preconditioned unit doses described above preferably concern unit doses for a single application. In order to be able to also add the unit doses through the dosing chamber of the dishwasher, their volume is advantageously below 25 ml, preferably between 10 and 25 ml, particularly preferably between 12 and 23 and particularly between 15 and 21 ml. The weight of these preconditioned unit doses preferably ranges between 10 and 30 g, particularly preferably between 13 and 27 g and particularly between 16 and 24 g. Dishwasher detergents in the form of a preconditioned unit dose that comprises between 0.5 and 4 g, preferably between 0.8 and 3.5 g, particularly preferably between 1.0 and 3.0 g and particularly between 1.5 and 2.5 g of non-ionic surfactants are particularly preferred in the scope of the present application.

The inventive solid dishwasher detergents are particularly suitable for cleaning glassware. Accordingly, a further subject matter of the present application is the use of the inventive dishwasher detergents for cleaning and rinsing glassware.

In addition to the abovementioned bleaching agents, non-ionic surfactants and polymers, the inventive dishwasher detergents preferably comprise additional active detergent and cleansing substances, particularly active detergent and cleansing substances from the group of the bleach activators, polymers, builders, surfactants, enzymes, disintegration aids, electrolytes, pH adjustors, fragrances, perfume carriers, dyes, hydrotropes, foam inhibitors, corrosion inhibitors and glass-corrosion inhibitors.

Builders

In the context of the present invention, the builders include especially the zeolites silicates, carbonates, organic co builders and also—where there are no ecological reasons preventing their use—phosphates.

Suitable crystalline, layered sodium silicates correspond to the general formula NaMSiₓO2ₓ₊₁.H₂O, wherein M is sodium or hydrogen, x is a number from 1.9 to 4 and y is a number from 0 to 20, preferred values for x being 2, 3 or 4. Preferred crystalline layered silicates of the given formula are those in which M stands for sodium and x assumes the values 2 or 3. Both β- and δ-sodium disilicates Na₂Si₂O₅.yH₂O are preferred.

Other useful builders are amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of this invention, the term “amorphous” also means “X-ray amorphous”. In other words, the silicates do not produce any of the sharp X-ray reflexions typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This can be interpreted to mean that the products have microcrystalline regions between 10 and a few hundred nm in size, values of up to at most 50 nm and especially up to at most 20 nm being preferred. This type of X-ray amorphous silicate similarly possesses a delayed dissolution in comparison with the customary water glasses. Compacted/densified amorphous silicates, compounded amorphous silicates and over dried X-ray amorphous silicates are particularly preferred.

In the context of the present invention, the detergents and cleansing agents preferably comprise silicate(s), preferably alkali silicates, particularly preferably crystalline or amorphous alkali disilicates in quantities of 10 to 60 wt. %, preferably 15 to 50 wt. % and especially 20 to 40 wt. %, each based on the weight of the detergent or cleansing agent.

When the silicates are incorporated as a component of dishwasher detergents, then they preferably comprise at least one crystalline layer-forming silicate of the general formula NaMSiₓO2ₓ₊₁.yH₂O, wherein M represents sodium or hydrogen, x is a number from 1.9 to 22, preferably 1.9 to 4 and y stands for a number from 0 to 33. The crystalline layer-forming silicates of the formula NaMSiₓO2₂ₓ₊₁.yH₂O are marketed for example by Clariant GmbH (Germany) under the trade names Na-SKS, eg. Na-SKS-1 (Na₂Si₂₂O₄₅.xH₂O, Kenyait), Na-SKS-2 (Na₂Si₁₄O₂₉.xH₂O, Magadiit), Na-SKS-3 (Na₂Si₈O₁₇.xH₂O) or Na-SKS-4 (Na₂Si₄O₉.xH₂O, Makatit).

Crystalline, layered silicates of the above formula, in which x stands for 2, are particularly suitable for the purposes of the present invention. Na-SKS-5 (α-Na₂Si₂O₅), Na-SKS-7 (β-Na₂Si₂O₅, Natrosilit), Na-SKS-9 (NaHSi₂O₅.H₂O), Na-SKS-10 (NaHSi₂O₅.3H₂O, Kanemit), Na-SKS-11 (t-Na₂Si₂O₅) and Na-SKS-13 (NaHSi₂O₅) are most notably suitable, particularly, however, Na-SKS-6 (δ-Na₂Si₂O₅).

In the context of the present application, if silicates are incorporated as components of dishwasher detergents, then these detergents comprise a content by weight of crystalline layered silicates of formula NaMSiₓO₂ₓ₊₁.yH₂O of 0.1 to 20 wt. %, preferably 0.2 to 15 wt. % and particularly 0.4 to 10 wt. %, each based on the total weight of the agent. Particularly preferred are especially those dishwasher detergents that have a total silicate content below 7 wt. %, advantageously below 6 wt. %, preferably below 5 wt. %, particularly preferably below 4 wt. %, quite particularly preferably below 3 wt. % and especially below 2.5 wt. %, wherein this silicate, based on the total weight of the comprised silicate is advantageously at least 70 wt. %, preferably at least 80 wt. % and especially at least 90 wt. % of a silicate of the general formula NaMSiₓO2ₓ₊₁.yH₂O.

Of the suitable fine crystalline, synthetic zeolites containing bound water, zeolite A and/or P are preferred. A particularly preferred zeolite P is zeolite MAP® (a commercial product of Crosfield). However, the zeolites X as well as mixtures of A, X and/or P are also suitable. Commercially available and preferred in the context of the present invention is, for example, also a co-crystallizate of zeolite X and zeolite A (ca. 80 wt. % zeolite X), which is marketed under the name of VEGOBOND AX® by Condea Augusta S.p.A. and which can be described by the Formula
nNa₂O.(1−n)K₂O.Al₂O₃.(2-2,5)SiO₂.(3.5-5.5)H₂O
The zeolite can be added both as the builder in a granular compound as well as being used as a type of ‘powdering’ of the total mixture being pressed, wherein normally, both ways are used to incorporate the zeolite in the premix. Suitable zeolites have a mean particle size of less than 10 μm (volume distribution, as measured by the Coulter Counter Method) and comprise preferably 18 to 22% by weight and more preferably 20 to 22% by weight of bound water.

Naturally, the generally known phosphates can also be added as builders, in so far that their use should not be avoided on ecological grounds. This is particularly true for the employment of the inventive agent as the dishwasher detergent, as is particularly preferred in the context of the present application. In the detergent and cleansing agent industry, among the many commercially available phosphates, the alkali metal phosphates are the most important and pentasodium or pentapotassium triphosphates (sodium or potassium tripolyphosphate) are particularly preferred.

“Alkali metal phosphates” is the collective term for the alkali metal salts (more particularly sodium and potassium) of the various phosphoric acids that can be differentiated into metaphosphoric acids (HPO₃)ₙ and orthophosphoric acid (H₃PO₄) in addition to representatives of higher molecular weight. The phosphates combine several advantages: they act as alkalinity sources, prevent lime deposits on machine parts and lime incrustations in fabrics and, in addition, contribute towards the cleansing power.

Exemplary suitable phosphates are sodium dihydrogen phosphate, NaH₂PO₄, in the form of the dihydrate (density 1.91 gcm⁻³ melting point 60°) or in the form of the monohydrate (density 2.04 gcm⁻³), disodium hydrogen phosphate (secondary sodium phosphate) Na₂HPO₄, that can be added in anhydrous form or with 2 mole (density 2.066 gcm⁻³, water loss at 95° C.), 7 mole (density 1.68 gcm³, melting point 48° C. losing 5H₂O) and 12 mole water (density 1.52 gcm⁻³, melting point 35° C. losing 5. H₂O), in particular, however, trisodium phosphate (tertiary sodium phosphate) Na₃PO₄, that can be added as the dodecahydrate, as the decahydrate (corresponding to 19-20% P₂O₅) and in anhydrous form (corresponding to 39-40% P₂O₅).

A further preferred phosphate is tripotassium phosphate (tertiary or tribasic potassium phosphate), K₃PO₄. Further preferred are tetrasodium diphosphate (sodium pyrophosphate), Na₄P₂O₇, which exists in anhydrous form (density 2.534 gcm⁻³, melting point 988°, a figure of 880° has also been mentioned) and as the decahydrate (density 1.815-1.836 gcm⁻³, melting point 94° with loss of water), as well as the corresponding potassium salt potassium diphosphate (potassium pyrophosphate) K₄P₂O₇.

Relatively high molecular weight sodium and potassium phosphates are formed by condensation of NaH₂PO₄ or KH₂PO₄. They may be divided into cyclic types, namely the sodium and potassium metaphosphates, and chain types, the sodium and potassium polyphosphates. The chain types in particular are known by various different names: fused or calcined phosphates, Graham's salt, Kurrol's salt and Maddrell's salt. All higher sodium and potassium phosphates are known collectively as condensed phosphates.

The industrially important pentasodium triphosphate, Na₅P₃O₁₀ (sodium tripolyphosphate), is anhydrous or crystallizes with 6H₂O to a non-hygroscopic white water-soluble salt of the general formula NaO—[P(O)(ONa)—O]ₙ—Na where n=3. The corresponding potassium salt pentapotassium triphosphate K₅P₃O₁₀ (potassium tripolyphosphate), is commercialised, for example in the form of a 50 wt. % solution (>23% P₂O₅, 25% K₂O). The potassium polyphosphates are widely used in the detergent industry. Sodium potassium tripolyphosphates also exist and are also usable in the scope of the present invention. They are formed for example when sodium trimetaphosphate is hydrolyzed with KOH:
(NaPO₃)₃+2 KOH→Na₃K₂P₃O₁₀+H₂O

According to the invention, they may be used in exactly the same way as sodium tripolyphosphate, potassium tripolyphosphate or mixtures thereof. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate may also be used in accordance with the invention.

In the context of the present invention, if phosphates are incorporated as the active detergent or cleansing substances in detergents or cleansing agents, then preferred agents comprise this/these phosphate(s), preferably alkali metal phosphate(s), particularly preferably pentasodium or pentapotassium triphosphate (sodium or potassium triphosphate) in quantities of 5 to 80 wt. %, preferably 15 to 75 wt. % and especially 20 to 70 wt. %, each based on the weight of the detergent or cleansing agent.

It is particularly preferred to incorporate potassium tripolyphosphate and sodium tripolyphosphate in a proportion by weight of greater than 1:1, preferably greater than 2:1, more preferably greater than 5:1, particularly preferably greater than 10:1 and especially greater than 20:1. It is particularly preferred to incorporate exclusively potassium tripolyphosphate without the addition of other phosphates.

Further builders are the alkalinity sources. Alkali metal hydroxides, alkali metal carbonates, alkali metal hydrogen carbonates, alkali metal sesquicarbonates, the cited alkali silicates, alkali metal silicates and mixtures of the cited materials are examples of alkalinity sources that can be used, the alkali carbonates being preferably used, especially sodium carbonate, sodium hydrogen carbonate or sodium sesquicarbonate in the context of this invention. A builder system comprising a mixture of tripolyphosphate and sodium carbonate is particularly preferred. A builder system comprising a mixture of tripolyphosphate and sodium carbonate and sodium disilicate is also particularly preferred. Because of their low chemical compatibility—in comparison with other builders—with the usual ingredients of detergents and cleansing agents, the alkali metal hydroxides are preferably only incorporated in low amounts, advantageously in amounts below 10 wt. %, preferably below 6 wt. %, particularly preferably below 4 wt. % and particularly below 2 wt. %, each based on the total weight of the detergent or cleansing agent. Agents that comprise less than 0.5 wt. %, based on the total weight, and in particular no alkali metal hydroxide, are particularly preferred.

Particularly preferred detergents and cleansing agents comprise carbonate(s) and/or hydrogen carbonate(s), preferably alkali carbonate(s), particularly preferably sodium carbonate in quantities of 2 to 50 wt. %, preferably 5 to 40 wt. % and especially 7.5 to 30 wt. %, each based on the weight of the detergent or cleansing agent. Particularly preferred agents comprise, based on the weight of the detergent or cleansing agent (i.e. the total weight of the combination product without packaging), less than 20 wt. %, advantageously less than 17 wt. %, preferably less than 13 wt. % and particularly less than 9 wt. % carbonate(s) and/or hydrogen carbonate(s), preferably alkali carbonates, particularly preferably sodium carbonate.

Organic co builders include, in particular, polycarboxylates/polycarboxylic acids, polymeric polycarboxylates, aspartic acid, polyacetals, dextrins, other organic co builders (see below) and phosphonates. These classes of substances are described below.

Useful organic builders are, for example, the polycarboxylic acids usable in the form of their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA), providing its use is not ecologically unsafe, and mixtures thereof. Preferred salts are the salts of polycarboxylic acids such as citric acid, adipic acid, succinic acid, glutaric acid, tartaric acid, sugar acids and mixtures thereof.

Acids per se can also be used. Besides their building effect, the acids also typically have the property of an acidifying component and, hence also serve to establish a relatively low and mild pH in detergents and cleansing agents. Citric acid, succinic acid, glutaric acid, adipic acid, gluconic acid and any mixtures thereof are particularly mentioned in this regard.

Other suitable builders are additional polymeric polycarboxylates, for example the alkali metal salts of polyacrylic or polymethacrylic acid, for example those with a relative molecular weight of 500 to 70 000 g/mol.

The molecular weights mentioned in this specification for the polymeric polycarboxylates are weight-average molecular weights M_{w} of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ significantly from the molecular weights measured against polystyrene sulfonic acids as standard. The molecular weights measured against polystyrene sulfonic acids are generally significantly higher than the molecular weights mentioned in this specification.

Particularly suitable polymers are the polyacrylates, which preferably have a molecular weight of 2000 to 20 000 g/mol. By virtue of their superior solubility, preferred representatives of this group are again the short-chain polyacrylates, which have molecular weights of 2000 to 10 000 g/mol and, more particularly, 3000 to 5000 g/mol.

Further suitable copolymeric polycarboxylates are particularly those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2000 to 70 000 g/mol, preferably 20 000 to 50 000 g/mol and especially 30 000 to 40 000 g/mol.

The (co)polymeric polycarboxylates can be added either as powders or as aqueous solutions. The (co)polymeric polycarboxylate content of the detergents or cleansing agents is preferably from 0.5 to 20% by weight, in particular from 3 to 10% by weight.

In order to improve the water solubility, the polymers can also comprise allylsulfonic acids as monomers, such as for example, allyloxybenzenesulfonic acid and methallylsulfonic acid

Particular preference is also given to biodegradable polymers comprising more than two different monomer units, examples being those comprising, as monomers, salts of acrylic acid and of maleic acid, and also vinyl alcohol or vinyl alcohol derivatives, or those comprising, as monomers, salts of acrylic acid and of 2-alkylallylsulfonic acid, and also sugar derivatives.

Other preferred copolymers are those, which preferably contain acrolein and acrylic acid/acrylic acid salts or acrolein and vinyl acetate as monomers.

Similarly, other preferred builders are polymeric aminodicarboxylic acids, salts or precursors thereof. Polyaspartic acids or their salts are particularly preferred.

Further preferred builders are polyacetals that can be obtained by treating dialdehydes with polyol carboxylic acids that possess 5 to 7 carbon atoms and at least 3 hydroxyl groups. Preferred polyacetals are obtained from dialdehydes like glyoxal, glutaraldehyde, terephthalaldehyde as well as their mixtures and from polycarboxylic acids like gluconic acid and/or glucoheptonic acid.

Further suitable organic builders are dextrins, for example oligomers or polymers of carbohydrates that can be obtained by the partial hydrolysis of starches. The hydrolysis can be carried out using typical processes, for example acidic or enzymatic catalyzed processes. The hydrolysis products preferably have average molecular weights in the range 400 to 500 000 g/mol. A polysaccharide with a dextrose equivalent (DE) of 0.5 to 40 and, more particularly, 2 to 30 is preferred, the DE being an accepted measure of the reducing effect of a polysaccharide in comparison with dextrose, which has a DE of 100. Both maltodextrins with a DE between 3 and 20 and dry glucose syrups with a DE between 20 and 37 and also so-called yellow dextrins and white dextrins with relatively high molecular weights of 2000 to 30 000 g/mol may be used.

The oxidized derivatives of such dextrins concern their reaction products with oxidizing agents that are capable of oxidizing at least one alcohol function of the saccharide ring to the carboxylic acid function.

Oxydisuccinates and other derivatives of disuccinates, preferably ethylenediamine disuccinate are also further suitable cobuilders. Ethylenediamine-N,N′-disuccinate (EDDS) is preferably used here in the form of its sodium or magnesium salts. In this context, glycerin disuccinates and glycerin trisuccinates are also preferred. Suitable addition quantities in zeolite-containing and/or silicate-containing formulations range from 3 to 15% by weight.

Other useful organic co-builders are, for example, acetylated hydroxycarboxylic acids and salts thereof which optionally may also be present in lactone form and which contain at least 4 carbon atoms, at least one hydroxyl group and at most two acid groups.

The phosphonates represent a further class of substances with cobuilder properties. In particular, they are hydroxyalkane phosphonates or aminoalkane phosphonates. Among the hydroxyalkane phosphonates, 1-hydroxyethane-1,1-diphosphonate (HEDP) is of particular importance as the cobuilder. It is normally added as the sodium salt, the disodium salt reacting neutral and the tetrasodium salt reacting alkaline (pH 9). Ethylenediamine tetramethylene phosphonate (EDTMP), diethylenetriamine pentamethylene phosphonate (DTPMP) and their higher homologs are preferably chosen as aminoalkane phosphonates. They are preferably added in the form of the neutral-reacting sodium salts, e.g. as the hexasodium salt of EDTMP or as the hepta and octasodium salt of DTPMP. Of the phosphonates, HEDP is preferably used as the builder. The aminoalkane phosphonates additionally possess a pronounced ability to complex heavy metals. Accordingly, it can be preferred, particularly where the agents also contain bleach, to use aminoalkane phosphonates, particularly DTPMP, or mixtures of the mentioned phosphonates.

In addition, any compounds capable of forming complexes with alkaline earth metal ions may be used as co-builders.

In the scope of the present application, particularly preferred dishwasher detergents according to the invention comprise 10 to 80 wt. %, preferably 15 to 75 wt. %, particularly preferably 20 to 70 wt. % and particularly 25 to 65 wt. % of one or more water-soluble builders.

Surfactants

In addition to the non-ionic surfactants described above, the group of surfactants also includes the anionic, cationic and amphoteric surfactants.

Exemplary suitable anionic surfactants are those of the sulfonate and sulfate type. Suitable surfactants of the sulfonate type are advantageously C₉₋₁₃-alkylbenzene sulfonates, olefin sulfonates, i.e. mixtures of alkene- and hydroxyalkane sulfonates, and disulfonates, as are obtained, for example, from C₁₂₋₁₈-monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, with subsequent hydrolysis or neutralization, are also suitable. The esters of α-sulfofatty acids (ester sulfonates), e.g. the α-sulfonated methyl esters of hydrogenated coco-, palm nut- or tallow acid are likewise suitable.

Further suitable anionic surfactants are sulfated fatty acid esters of glycerine. They include the mono-, di- and triesters and also mixtures of them, such as those obtained by the esterification of a monoglycerin with 1 to 3 moles fatty acid or the transesterification of triglycerides with 0.3 to 2 moles glycerin. Preferred sulfated fatty acid esters of glycerol in this case are the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali and especially sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petro-chemical basis, which show similar degradation behaviour to the suitable compounds based on fat chemical raw materials. The C₁₂-C₁₆-alkyl sulfates and C₁₂-C₁₅-alkyl sulfates and C₁₄-C₁₅ alkyl sulfates are preferred on the grounds of laundry performance. 2,3 alkyl sulfates, which can be obtained from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, for example 2-methyl-branched C₉₋₁₁ alcohols with an average of 3.5 mol ethylene oxide (EO) or C₁₂₋₁₈ fatty alcohols with 1 to 4 EO. Due to their high foaming performance, they are only used in fairly small quantities in cleansing agents, for example in amounts of 1 to 5% by weight.

Other suitable anionic surfactants are the salts of alkylsulfosuccinic acid, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates contain C₈₋₁₈ fatty alcohol groups or mixtures of them. Especially preferred sulfosuccinates contain a fatty alcohol residue derived from the ethoxylated fatty alcohols that are under consideration as non-ionic surfactants (see description below). Once again the especially preferred sulfosuccinates are those, whose fatty alcohol residues are derived from ethoxylated fatty alcohols with narrow range distribution. It is also possible to use alk(en)ylsuccinic acid with preferably 8 to 18 carbon atoms in the alk(en)yl chain, or salts thereof.

Soaps in particular can be considered as further anionic surfactants. Saturated fatty acid soaps are suitable, such as the salts of lauric acid, myristic acid, palmitic acid, stearic acid, hydrogenated erucic acid and behenic acid, and especially soap mixtures derived from natural fatty acids such as coconut oil fatty acid, palm kernel oil fatty acid or tallow fatty acid.

Anionic surfactants, including soaps may be in the form of their sodium, potassium or ammonium salts or as soluble salts of organic bases, such as mono-, di- or triethanolamine. Preferably, anionic surfactants are in the form of their sodium or potassium salts, especially sodium.

When the anionic surfactants are components of dishwasher detergents, their content, based on the total weight of the agent, is advantageously less than 4% by weight, preferably less than 2% by weight and quite particularly preferably less than 1% by weight. Dishwasher detergents, which comprise no anionic surfactants, are particularly preferred.

Cationic and/or amphoteric surfactants can be added instead of, or in combination with the cited surfactants.

As the cationic active substances, cationic compounds of the following three Formulae IX, X or XI can be incorporated for example: 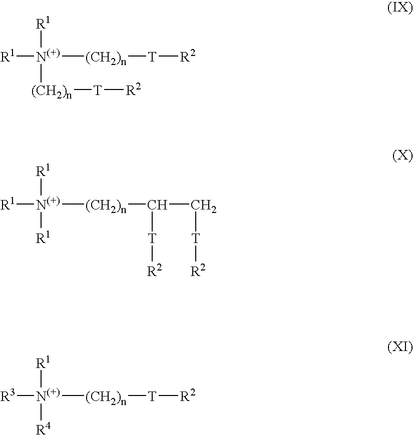
in which each group R¹, independently of one another, is chosen from C₁₋₆-alkyl, -alkenyl or -hydroxyalkyl groups; each group R², independently of one another, is chosen from C₈₋₂₈-alkyl or -alkenyl groups; R³═R¹ or (CH₂)ₙ—T—R²; R⁴═R¹ or R² or (CH₂)ₙ—T—R²; T=—CH₂—, —O—CO— or —CO—O— and n is an integer from 0 to 5.

In dishwasher detergents, the content of cationic and/or amphoteric surfactants is advantageously less than 6% by weight, preferably less than 4% by weight, quite particularly preferably less than 2% by weight and in particular less than 1% by weight. Dishwasher detergents, which comprise no cationic or amphoteric surfactants, are particularly preferred.

Polymers

The group of polymers includes, in particular the active detergent polymers or active cleansing polymers, for example, the rinsing polymers and/or polymers active for water softening. Generally, in addition to non-ionic polymers, cationic, anionic or amphoteric polymers are suitable for incorporation in detergents or cleansing agents.

Exemplary polymers active for water softening are polymers with sulfonic acid groups, which are especially preferably added.

Particularly preferred suitable polymers comprising sulfonic acid groups are copolymers of unsaturated carboxylic acids, monomers comprising sulfonic acid groups and optional further ionic or non-ionogenic monomers.

In the context of the present invention, unsaturated carboxylic acids of Formula XII are preferred monomers,
R¹(R²)C═C(R³)COOH (XII),
in which R¹ to R³ independently of one another stands for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon group containing 1 to 12 carbon atoms.

Among the unsaturated carboxylic acids corresponding to Formula XII, acrylic acid (R¹═R²═R³═H), methacrylic acid (R¹═R²═H; R³═CH₃) and/or maleic acid (R¹═COOH; R²═R³═H) are particularly preferred.

The preferred monomers containing sulfonic acid groups correspond to those of the Formula XIII,
R⁵(R⁶)C═C(R⁷)—X—SO₃H (XIII),
in which R⁵ to R⁷ independently of one another stand for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon group containing 1 to 12 carbon atoms, and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Among these monomers, those corresponding to Formulae XIIIa, XIIIb and/or XIIIc are preferred,
H₂C═CH—X—SO₃H (XIIIa),
H₂C═C(CH₃)—X—SO₃H (XIIIb),
HO₃S—X—(R⁶)C═C(R⁷)—X—SO₃H (XIIIc),
in which R⁶ und R⁷ independently of one another are selected from —H, —CH₃, —CH₂CH₃, —CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid (X=—C(O)NH—CH(CH₂CH₃) in formula XIa), 2-acrylamido-2-propanesulfonic acid (X=—C(O)NH—C(CH₃)₂ in formula XIIIa), 2-acrylamido-2-methyl-1-propanesulfonic acid (X=—C(O)NH—CH(CH₃)CH₂— in formula XIIIa), 2-methacrylamido-2-methyl-1-propanesulfonic acid (X=—C(O)NH—CH(CH₃)CH₂— in formula XIIIb), 3-methacrylamido-2-hydroxypropanesulfonic acid (X=—C(O)NH—CH₂CH(OH)CH₂— in formula XIIIb), allyl sulfonic acid (X═CH₂ in formula XIIIa), methallylsulfonic acid (X═CH₂ in formula XIIIb), allyloxybenzenesulfonic acid (X=—CH₂—O—C₆H₄— in formula XIIIa), methallyloxybenzenesulfonic acid (X=—CH₂—O—C₆H₄— in formula XIIIb), 2-hydroxy-3-(2-propenyloxy)-propanesulfonic acid, 2-methyl-2-propene-1-sulfonic acid (X═CH₂ in formula XIIIb), styrenesulfonic acid (X═C₆H₄ in formula XIIIa), vinylsulfonic acid (X not present in formula XIIIa), 3-sulfopropyl acrylate (X=—C(O)NH—CH₂CH₂CH₂— in formula XIIIa), 3-sulfopropyl methacrylate (X=—C(O)NH—CH₂CH₂CH₂— in formula XIIIb), sulfomethacrylamide (X=—C(O)NH— in formula XIIIb), sulfomethylmethacrylamide (X=—C(O)NH—CH₂— in formula XIIIb) and water-soluble salts of the acids mentioned.

Additional ionic or non-ionogenic monomers are particularly ethylenically unsaturated compounds. The polymers used in accordance with the invention preferably contain less than 20% by weight, based on polymer, of monomers belonging to group iii). Particularly preferred polymers for use consist solely of monomers belonging to groups i) and ii).

In summary copolymers of

i) unsaturated carboxylic acids of Formula XII
R¹(R²)C═C(R³)COOH (XII),
in which R¹ to R³ independently of one another stands for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon group containing 1 to 12 carbon atoms,
ii) monomers containing sulfonic acid groups corresponding to Formula XIII
R⁵(R⁶)C═C(R⁷)—X—SO₃H (XIII),
in which R⁵ to R⁷ independently of one another stands for —H, —CH₃, a linear or branched, saturated alkyl group containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon group containing 1 to 12 carbon atoms and X stands for an optionally present spacer group, selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—
iii) optional additional ionic or non-ionic monomers are particularly preferred.

Further particularly preferred copolymers consist of
i) one or a plurality of unsaturated carboxylic acids from the group acrylic acid, methacrylic acid and/or maleic acid
ii) one or a plurality of monomers containing sulfonic acid groups corresponding to Formulae XIIIa, XIIIb and/or XIIIc:
   H₂C═CH—X—SO₃H (XIIIa),
   H₂C═C(CH₃)—X—SO₃H (XIIIb),
   HO₃S—X—(R⁶)C═C(R⁷)—X—SO₃H (XIIIc),
   in which R⁶ and R⁷ independently of one another are selected from —H, —CH₃, —CH₂CH₃, —CH₂CH₂CH₃, —CH(CH₃)₂ and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—
iii) optional additional ionic or non-ionic monomers.

The copolymers can contain monomers from groups (i) and (ii) and optionally (iii) in varying amounts, wherein all representatives of group (i) can be combined with all representatives of group (ii) and all representatives of group (iii). Particularly preferred polymers have defined structural units, which are described below.

For example, copolymers are preferred, which comprise structural units of Formula XIV
—[CH₂—CHCOOH]ₘ—[CH₂—CHC(O)—Y—SO₃H]ₚ— (XIV),
in which m and p each stand for a whole natural number between 1 and 2000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

These polymers are produced by copolymerization of acrylic acid with an acrylic acid derivative containing sulfonic acid groups. If the acrylic acid derivative containing sulfonic acid groups is copolymerized with methacrylic acid, then another polymer results whose incorporation is likewise preferred. The appropriate copolymers comprise structural units of Formula XV
—[CH₂—C(C H₃)COOH]ₘ—[CH₂—CHC(O)—Y—SO₃H]ₚ— (XV),
in which m and p each stand for a whole natural number between 1 and 2000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

Entirely analogously, acrylic acid and/or methacrylic acid may also be copolymerized with methacrylic acid derivatives containing sulfonic acid groups, so that the structural units in the molecule are changed. Consequently, copolymers that comprise structural units of Formula XVI
—[CH₂—CHCOOH]ₘ—[CH₂—C(CH₃)C(O)—Y—SO₃H]ₚ— (XVI),
in which m and p each stand for a whole natural number between 1 and 2000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are also preferred as copolymers that have structural units of Formula XVII.
—[CH₂—C(CH₃)COOH]ₘ—[CH₂—C(CH₃)C(O)—Y—SO₃H]ₚ— (XVII),
in which m and p each stand for a whole natural number between 1 and 2000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)—.

Instead of acrylic acid and/or methacrylic acid or in addition to them, maleic acid can also be incorporated as the particularly preferred monomer from group i). In this way, one arrives at inventively preferred copolymers that comprise structural units of the Formula XVIII
—[HOOCCH—CHCOOH]ₘ—[CH₂—CHC(O)—Y—SO₃H]ₚ— (XVIII),
in which m and p each stand for a whole natural number between 1 and 2000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred, and to inventively preferred copolymers that comprise structural units corresponding to Formula XIX
—[HOOCCH—CHCOOH]ₘ—[CH₂—C(CH₃)C(O)O—Y—SO₃H]ₚ— (XIX),
in which m and p each stand for a whole natural number between 1 and 2000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

In summary, preferred copolymers according to the invention comprise structural units of Formula XIV and/or XV and/or XVI and/or XVII and/or XVIII and/or XIX

| | |
|---|---|
| —[CH₂—CHCOOH]ₘ—[CH₂—CHC(O)—Y—SO₃H]ₚ— | (XIV), |
| —[CH₂—C(CH₃)COOH]ₘ—[CH₂—CHC(O)—Y—SO₃H]ₚ— | (XV), |
| —[CH₂—CHCOOH]ₘ—[CH₂—C(CH₃)C(O)—Y—SO₃H]ₚ— | (XVI), |
| —[CH₂—C(CH₃)COOH]ₘ—[CH₂—C(CH₃)C(O)—Y—SO₃H]ₚ— | (XVII), |
| —[HOOCCH—CHCOOH]ₘ—[CH₂—CHC(O)—Y—SO₃H]ₚ— | (XVIII), |
| —[HOOCCH—CHCOOH]ₘ—[CH₂—C(CH₃)C(O)O—Y—SO₃H]ₚ— | (XIX), |

in which m and p each stand for a whole natural number between 1 and 2000 and Y stands for a spacer group selected from substituted or unsubstituted aliphatic, aromatic or araliphatic hydrocarbon groups containing 1 to 24 carbon atoms, wherein spacer groups, in which Y represents —O—(CH₂)ₙ— with n=0 to 4, —O—(C₆H₄)—, —NH—C(CH₃)₂— or —NH—CH(CH₂CH₃)— are preferred.

The sulfonic acid groups may be present in the polymers completely or partly in neutralized form, i.e. the acidic hydrogen atom of the sulfonic acid groups can be replaced by metal ions, preferably alkali metal ions and more particularly sodium ions, in some or all of the sulfonic acid groups. The addition of copolymers containing partly or fully neutralized sulfonic acid groups is preferred according to the invention.

The monomer distribution of the inventively preferred copolymers used ranges for copolymers that comprise only monomers defined in groups (i) and (ii) from preferably 5 to 95 wt. % (i) and (ii) respectively, particularly preferably 50 to 90 wt. % monomer from group (i) and 10 to 50 wt. % monomer from group (ii) respectively, based on the polymer.

Particularly preferred terpolymers are those that comprise 20 to 85 wt. % monomer from group (i), 10 to 60 wt. % monomer from group (ii) and 5 to 30 wt. % monomer from group (iii).

The molecular weight of the inventively preferred sulfo-copolymers used can be varied to adapt the properties of the polymer to the desired application requirement. Preferred detergents or cleansing agent compositions are characterized in that the molecular weights of the copolymers are 2000 to 200 000 gmol⁻¹, preferably 4000 to 25 000 gmol⁻¹ and especially 5000 to 15 000 gmol⁻¹.

Bleaching Agents

The detergents or cleansing agents can comprise bleach activators in order to achieve an improved bleaching action on washing or cleaning at temperatures of 60° C. and below. Bleach activators, which can be used are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or isononanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran.

In the context of the present application, further preferred added bleach activators are compounds from the group of cationic nitriles, particularly cationic nitriles of the Formula 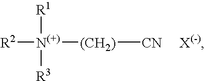
in which R¹ stands for —H, —CH₃, a C₂₋₂₄ alkyl or alkenyl group, a substituted C₂₋₂₄ alkyl or alkenyl group having at least one substituent from the group of —Cl, —Br, —OH, —NH₂, —CN, an alkyl or alkenylaryl group having a C₁₋₂₄ alkyl group or for a substituted alkyl or alkenylaryl group having a C₁₋₂₄ alkyl group and at least a further substituent on the aromatic ring, R² and R³, independently of one another are selected from —CH₂—CN, —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, —(CH₂CH₂—O)ₙH with n=1, 2, 3, 4, 5 or 6 and X is an anion.

Particularly preferably, a cationic nitrile of the formula 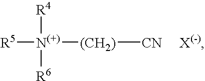
is particularly preferred, in which R⁴, R⁵ and R⁶ independently of one another are selected from —CH₃, —CH₂—CH₃, —CH₂—CH₂—CH₃, —CH(CH₃)—CH₃, wherein R⁴ can also be —H and X is an anion, wherein preferably R⁵═R⁵=—CH₃ and in particular R⁴═R⁵═R⁵=—CH₃ and compounds of the formulae (CH₃)₃N⁽⁺⁾CH₂—CN X⁻, (CH₃CH₂)₃N⁽⁺⁾CH₂—CN X⁻, (CH₃CH₂CH₂)₃N⁽⁺⁾CH₂—CN X⁻, (CH₃CH(CH₃))₃N⁽⁺⁾CH₂—CN X⁻, or (HO—CH₂—CH₂)₃N⁽⁺⁾CH₂—CN X⁻ are particularly preferred, wherein once again the cationic nitrile of the formula (CH₃)₃N⁽⁺⁾CH₂—CN X⁻, in which X⁻ stands for an anion selected from the group chloride, bromide, iodide, hydrogen sulfate, methosulfate, p-toluene sulfonate (tosylate) or xylene sulfonate.

Bleach activators, which can be used are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or isononanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran, N-methyl-morpholinium-acetonitrile-ethyl sulfate (MMA) as well as acetylated sorbitol and mannitol or their mixtures (SORMAN), acylated sugar derivatives, in particular pentaacetyl glucose (PAG), pentaacetyl fructose, tetraacetyl xylose and octaacetyl lactose as well as acetylated, optionally N-alkylated glucamine and gluconolactone, and/or N-acylated lactams, for example N-benzoyl caprolactam. Hydrophillically substituted acyl acetals and acyl lactams are also preferably used. Combinations of conventional bleach activators may also be used.

In addition to, or instead of the conventional bleach activators mentioned above, so-called bleach catalysts may also be incorporated. These substances are bleach-boosting transition metal salts or transition metal complexes such as, for example, manganese-, iron-, cobalt-, ruthenium- or molybdenum-salen or -carbonyl complexes. Manganese, iron, cobalt, ruthenium, molybdenum, titanium, vanadium and copper complexes with nitrogen-containing tripod ligands, as well as cobalt-, iron-, copper- and ruthenium-ammine complexes may also be employed as the bleach catalysts.

When additional bleach activators are intended to be used in addition to the nitrilequats, preferred bleach activators are added from the group of polyacylated alkylenediamines, more particularly tetraacetyl ethylenediamine (TAED), N-acyl imides, more particularly N-nonanoyl succinimide (NOSI), acylated phenol sulfonates, more particularly n-nonanoyl- or isononanoyl-oxybenzene sulfonate (n- or iso-NOBS), N-methyl morpholinium acetonitrile methyl sulfate (MMA), preferably in quantities of up to 10% by weight, more preferably in quantities of 0.1% by weight to 8% by weight, especially 2 to 8% by weight and especially preferably 2 to 6% by weight, based on the total weight of the bleach activator-containing agent.

Bleach-boosting transition metal complexes, more particularly containing the central atoms Mn, Fe, Co, Cu, Mo, V, Ti and/or Ru, preferably selected from the group of manganese and/or cobalt salts and/or complexes, particularly preferably the cobalt (ammine) complexes, cobalt (acetate) complexes, cobalt (carbonyl) complexes, chlorides of cobalt or manganese and manganese sulfate, are also used in typical quantities, preferably in a quantity of up to 5% by weight, especially in a quantity of 0.0025% by weight to 1% by weight and particularly preferably in a quantity of 0.01% by weight to 0.25% by weight, based on the total weight of the bleach activator-containing agent. In special cases, however, even more bleach activator may be used.

Glass Corrosion Inhibitors

Glass corrosion inhibitors prevent the occurrence of smears, streaks and scratches as well as iridescence on the glass surface of glasses washed in an automatic dishwasher. Preferred glass corrosion inhibitors come from the group of magnesium and/or zinc salts and/or magnesium and/or zinc complexes.

A preferred class of compounds that can be used to prevent glass corrosion are insoluble zinc salts.

In terms of the preferred embodiment, insoluble zinc salts are zinc salts with a solubility of maximum 10 grams zinc salt per liter of water at 20° C. According to the invention, examples of particularly preferred insoluble zinc salts are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

The cited zinc compounds are preferably used in quantities that produce an amount of zinc ions in the agent between 0.02 and 10 wt. %, preferably between 0.1 and 5.0 wt. % and especially between 0.2 and 1.0 wt. %, based on the total agent containing the glass corrosion inhibitor. The exact content of the zinc salt or zinc salts in the agent naturally depends on the type of zinc salt—the lower the solubility of the added zinc salt, the higher must be its concentration in the agents.

As for the most part the insoluble zinc salts remain unchanged during the dishwasher process, the particle size of the salts is an important criteria for the salts not to stick to the glassware or machine parts. Agents are preferred in which the insoluble zinc salts have a particle size below 1.7 mm.

When the maximum particle size of the insoluble zinc salt lies below 1.7 mm, one need not worry about insoluble residues in the dishwasher. Preferably, in order to further minimise the danger of insoluble residues, the insoluble zinc salt has an average particle size that lies markedly below this value, for example an average particle size of less than 250 μm. This is more and more true as the solubility of the zinc salt decreases. In addition, the efficiency of the glass corrosion inhibition increases with decreasing particle size. For zinc salts with very low solubility, the particle size preferably lies below 100 μm. For zinc salts with even lower solubility, it can be even less; for example the average particle size for the very poorly soluble zinc oxide preferably lies below 100 μm.

A further preferred class of compounds are magnesium and/or zinc salt(s) of at least one monomeric and/or polymeric organic acid. These ensure that even on repeated use, the surfaces of the glassware are not corroded, especially that no smears, streaks and scratches or iridescence occur on the glass surfaces.

Although any magnesium and/or zinc salt(s) of monomeric and/or polymeric organic acids can be used, the magnesium and/or zinc salt(s) of monomeric and/or polymeric organic acids from the groups of the non-branched, saturated or unsaturated monocarboxylic acids, the branched, saturated or unsaturated monocarboxylic acids, the saturated and unsaturated dicarboxylic acids, the aromatic mono-, di- and tricarboxylic acids, the sugar acids, the hydroxy acids, the oxoacids, the amino acids and/or the polymeric carboxylic acids.

The spectrum of the inventive preferred zinc salts of organic acids, preferably organic carboxylic acids, ranges from salts that are difficulty soluble or insoluble in water, i.e. with a solubility below 100 mg/L, preferably below 10 mg/L, or especially are insoluble, to such salts with solubilities in water greater than 100 mg/L, preferably over 500 mg/L, particularly preferably over 1 g/L and especially over 5 g/L (all solubilities at a water temperature of 20° C.). The first group of zinc salts includes zinc citrate, zinc oleate and zinc stearate, the group of soluble zinc salts includes for example, zinc formate, zinc acetate, zinc lactate und zinc gluconate.

A particular advantageous glass corrosion inhibitor is a zinc salt of an organic carboxylic acid, particularly preferably a zinc salt from the group zinc stearate, zinc oleate, zinc gluconate, zinc acetate, zinc lactate and/or zinc citrate. Zinc ricinoleate, zinc abietate and zinc oxalate are also preferred.

In the context of the present invention, the content of zinc salt in the cleansing agent is advantageously between 0.1 and 5 wt. %, preferably between 0.2 and 4.0 wt. % and especially between 0.4 and 3 wt. %, and the content of zinc in the oxidized form (calculated as Zn²⁺) between 0.01 and 1 wt. %, preferably between 0.02 and 0.5 wt. % and especially between 0.04 and 0.2 wt. % respectively, based on the total weight of the agent containing the glass corrosion inhibitor.

Corrosion Inhibitors

Corrosion inhibitors serve to protect the tableware or the machine, silver protection agents being particularly important in automatic dishwashing. Substances known from the prior art can be incorporated. Above all, silver protectors selected from the group of triazoles, benzotriazoles, bisbenzotriazoles, aminotriazoles, alkylaminotriazoles and the transition metal salts or complexes may generally be used. Benzotriazole and/or alkylaminotriazole are particularly preferably used. Exemplary inventively preferred suitable 3-amino-5-alkyl-1,2,4-triazoles can be cited: 5-propyl-, -butyl-, -pentyl-, -heptyl-, -octyl-, -nonyl-, -decyl-, -undecyl-, -dodecyl-, -isononyl-, -versatic-10-acidalkyl-, -phenyl-, -p-tolyl-, -(4-tert. butylphenyl)-, -(4-methoxyphenyl)-, -(2-, -3-, -4-pyridyl)-, -(2-thienyl)-, -(5-methyl-2-furyl)-, -(5-oxo-2-pyrrolidinyl)-, -3-amino-1,2,4-triazole. In dishwasher detergents, the alkylamino-1,2,4-triazoles or their physiologically compatible salts are used in a concentration of 0.001 to 10 wt. %, preferably 0.0025 to 2 wt. %, particularly preferably 0.01 to 0.04 wt. %. Preferred acids for the salt formation are hydrochloric acid, sulfuric acid, phosphoric acid, carbonic acid, sulfurous acid, organic carboxylic acids like acetic acid, glycolic acid, citric acid, succinic acid. Quite particularly active are 5-pentyl-, 5-heptyl-, 5-nonyl-, 5-undecyl-, 5-isononyl-, 5-versatic-10-acidalkyl-3-amino-1,2,4-triazoles as well as mixtures of these substances.

Frequently encountered in cleansing formulations, furthermore, are agents containing active chlorine, which may significantly reduce corrosion of the silver surface. In chlorine-free cleansing products, particular use is made of oxygen-containing and nitrogen-containing organic redox-active compounds, such as dihydric and trihydric phenols, e.g. hydroquinone, pyrocatechol, hydroxyhydroquinone, gallic acid, phloroglucinol, pyrogallol and derivatives of these classes of compound. Salts and complexes of inorganic compounds, such as salts of the metals Mn, Ti, Zr, Hf, V, Co and Ce are also frequently used. Preference is given in this context to the transition metal salts selected from the group consisting of manganese and/or cobalt salts and/or complexes, particularly preferably cobalt ammine complexes, cobalt acetato complexes, cobalt carbonyl complexes, the chlorides of cobalt or of manganese, and manganese sulfate. Zinc compounds may also be used to prevent corrosion of tableware.

Redox-active substances may be added instead of, or in addition to the above described silver protection agents, e.g. the benzotriazoles. These substances are preferably inorganic redox-active substances from the group of salts and/or complexes of manganese, titanium, zirconium, hafnium, vanadium, cobalt or cerium, in which the cited metals exist in the valence states II, III, IV, V or VI.

The metal salts or complexes used should be at least partially soluble in water. Suitable counterions for the salt formation include all usual mono, di or trivalent negatively charged inorganic anions, e.g. oxide, sulfate, nitrate, fluoride and also organic anions e.g. stearate. In the context of the invention, metal complexes are compounds that consist of a central atom and one or several ligands as well as optionally one or several of the abovementioned anions in addition. The central atom is one of the abovementioned metals in one of the abovementioned valence states. Ligands are neutral molecules or anions, which are monodentate or bidentate; in the context of the invention, the term “ligands” is discussed in more detail in “Römpp Chemie Lexikon, Georg Thieme Verlag Stuttgart/New York, 9. Edition, 1990, page 2507”. If the charge on the central atom and the charge of the ligand(s) do not add up to zero, then according to whether a cationic or an anionic residual charge is present, either one or several of the abovementioned anions or one or more of the cations e.g. sodium, potassium, ammonium ions equalise the charge difference. Suitable complex builders are e.g. citrate, acetylacetonate or 1-hydroxyethane-1,1-diphosphonate.

The current definition for “valence state” in chemistry is given in “Römpp Chemie Lexikon, Georg Thieme Verlag Stuttgart/New York, 9. Edition, 1991, page 3168”.

Particularly preferred metal salts and/or metal complexes are selected from the group MnSO4, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ as well as their mixtures, such that preferred inventive automatic dishwasher agents are characterized in that the metal salts and/or metal complexes are selected from the group MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃.

These metal salts and/or metal complexes are generally commercially available substances that can be added in the inventive agents for silver corrosion protection without prior cleaning. The mixture of pentavalent and tetravalent vanadium (V₂O₅, VO₂, V₂O₄), known from the SO₃ manufacturing process (Contact Process) is suitable, for example, similarly titanyl sulfate, TiOSO₄ that is formed by diluting a solution of Ti(SO₄)₂.

The inorganic redox-active substances, particularly metal salts or metal complexes are preferably coated, i.e. completely coated with a water-impermeable material that is easily soluble at the cleaning temperature, so as to prevent any premature decomposition or oxidation on storage. Preferred coating materials, which are applied using known processes, for instance hot melt coating process from Sandwik in the food industry, are paraffins, microwaxes, waxes of natural origin such as candelilla wax, carnuba wax, beeswax, higher-melting alcohols such as for example hexadecanol, soaps or fatty acids. The coating material, which is solid at room temperature, is applied in the molten state onto the material to be coated, e.g. by projecting a continuous stream of finely-divided material to be coated through a likewise continuously produced atomized spray zone of molten coating material. The melting point must be chosen such that the coating material easily dissolves during the silver treatment and quickly solidifies. The melting point should ideally lie in the range 45° C. and 65° C. and preferably in the range 50° C. to 60° C.

The cited metal salts and/or metal complexes are comprised in the cleansing agents, preferably in a quantity of 0.05 to 6 wt. %, preferably 0.2 to 2.5 wt. %, each based on the total weight of the agent containing the corrosion inhibitor.

Enzymes

Enzymes can be incorporated to increase the washing or cleansing performance of detergents or cleansing agents. These particularly include proteases, amylases, lipases, hemicellulases, cellulases or oxidoreductases as well as preferably their mixtures. In principle, these enzymes are of natural origin; improved variants based on the natural molecules are available for use in detergents and accordingly they are preferred. The agents according to the invention preferably comprise enzymes in total quantities of 1×10⁻⁶ to 5 weight percent based on active protein. The protein concentration can be determined using known methods, for example the BCA Process or the biuret process.

Preferred proteases are those of the subtilisin type. Examples of these are subtilisins BPN′ and Carlsberg, the protease PB92, the subtilisins 147 and 309, the alkaline protease from Bacillus lentus, subtilisin DY and those enzymes of the subtilases no longer however classified in the stricter sense as subtilisines thermitase, proteinase K and the proteases TW3 und TW7. Subtilisin Carlsberg in further developed form is available under the trade name Alcalase® from Novozymes A/S, Bagsvaerd, Denmark. Subtilisins 147 and 309 are commercialised under the trade names Esperase® and Savinase® by the Novozymes company. The variants sold under the name BLAP® are derived from the protease from Bacillus lentus DSM 5483.

Further useable proteases are, for example, those enzymes available with the trade names Durazym®, Relase®, Everlase®, Nafizym, Natalase®, Kannase® and Ovozymes® from the Novozymes Company, those under the trade names Purafect®, Purafect® OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan.

Examples of further useable amylases according to the invention are the α-amylases from Bacillus licheniformis, from B. amyloliquefaciens and from B. stearothermophilus, as well as their improved further developments for use in detergents and cleaning agents. The enzyme from B. licheniformis is available from the Novozymes Company under the name Termamyl® and from the Genencor Company under the name Purastar®ST. Further development products of this α-amylase are available from the Novozymes Company under the trade names Duramyl® and Termamyl® ultra, from the Genencor Company under the name Purastar®OxAm and from Daiwa Seiko Inc., Tokyo, Japan as Keistase®. The α-amylase from B. amyloliquefaciens is commercialised by the Novozymes Company under the name BAN®, and derived variants from the α-amylase from B. stearothermophilus under the names BSG® and Novamyl® also from the Novozymes Company.

Moreover, for these purposes, attention should be drawn to the α-amylase from Bacillus sp. A 7-7 (DSM 12368) and the cyclodextrin-glucanotransferase (CGTase) from B. agaradherens (DSM 9948).

Moreover, further developments of α-amylase from Aspergillus niger und A. oryzae available from the Company Novozymes under the trade name Fungamyl® are suitable. A further commercial product is the amylase-LT® for example.

According to the invention, lipases or cutinases can also be incorporated, particularly due to their triglyceride cleaving activities, but also in order to produce in situ peracids from suitable preliminary steps. These include the available or further developed lipases originating from Humicola lanuginosa (Thermomyces lanuginosus), particularly those with the amino acid substitution D96L. They are commercialised, for example by the Novozymes Company under the trade names Lipolase®, Lipolase®Ultra, LipoPrime®, Lipozyme® and Lipex®. Moreover, suitable cutinases, for example are those that were originally isolated from Fusarium solani pisi and Humicola insolens. Likewise useable lipases are available from the Amano Company under the designations Lipase CE®, Lipase P®, Lipase B®, and Lipase CES®, Lipase AKG®, Bacillis sp. Lipase®, Lipase AP®, Lipase M-AP® and Lipase AML®. Suitable lipases or cutinases whose starting enzymes were originally isolated from Pseudomonas mendocina und Fusarium solanii are for example available from Genencor Company. Further important commercial products that may be mentioned are the commercial preparations Ml Lipase® und Lipomax® originally from Gist-Brocades Company, and the commercial enzymes from the Meito Sangyo KK Company, Japan under the names Lipase MY-30®, Lipase OF® and Lipase PL® as well as the product Lumafast® from Genencor Company.

In addition, enzymes, which are summarized under the term hemicellulases, can be added. These include, for example mannanases, xanthanlyases, pectinlyases (=pectinases), pectinesterases, pectatlyases, xyloglucanases (=xylanases), pullulanases und β-glucanases. Suitable mannanases, for example are available under the names Gamanase® and Pektinex AR® from Novozymes Company, under the names Rohapec® B1L from AB Enzymes and under the names Pyrolase® from Diversa Corp., San. Diego, Calif., USA. β-Glucanase extracted from B. subtilis is available under the name Cereflo® from Novozymes Company.

To increase the bleaching action, oxidoreductases, for example oxidases, oxygenases, katalases, peroxidases, like halo-, chloro-, bromo-, lignin-, glucose- or manganese-peroxidases, dioxygenases or laccases (phenoloxidases, polyphenoloxidases) can be incorporated according to the invention. Suitable commercial products are Denilite® 1 and 2 from the Novozymes Company. Advantageously, additional, preferably organic, particularly preferably aromatic compounds are added that interact with the enzymes to enhance the activity of the relative oxidoreductases or to facilitate the electron flow (mediators) between the oxidizing enzymes and the stains over strongly different redox potentials.

The enzymes either stem originally from microorganisms, such as the species Bacillus, Streptomyces, Humicola, or Pseudomonas, and/or are produced according to known biotechnological processes using suitable microorganisms such as by transgenic expression hosts of the species Bacillus or filamentary fungi.

Purification of the relevant enzymes follows conveniently using established processes such as precipitation, sedimentation, concentration, filtration of the liquid phases, microfiltration, ultrafiltration, mixing with chemicals, deodorization or suitable combinations of these steps.

The enzymes can be added in each established form according to the prior art. Included here, for example, are solid preparations obtained by granulation, extrusion or lyophilization, or particularly for liquid agents or agents in the form of gels, enzyme solutions, advantageously highly concentrated, of low moisture content and/or mixed with stabilizers.

As an alternative application form, the enzymes can also be encapsulated, for example by spray drying or extrusion of the enzyme solution together with a preferably natural polymer or in the form of capsules, for example those in which the enzyme is embedded in a solidified gel, or in those of the core-shell type, in which an enzyme-containing core is covered with a water-, air- and/or chemical-impervious protective layer. Further active principles, for example stabilizers, emulsifiers, pigments, bleaches or colorants can be applied in additional layers. Such capsules are made using known methods, for example by vibratory granulation or roll compaction or by fluid bed processes. Advantageously, these types of granulates, for example with an applied polymeric film former are dust-free and as a result of the coating are storage stable.

In addition, it is possible to formulate two or more enzymes together, so that a single granulate exhibits a plurality of enzymatic activities.

A protein and/or enzyme can be protected, particularly in storage, against deterioration such as, for example inactivation, denaturation or decomposition, for example through physical influences, oxidation or proteolytic cleavage. An inhibition of the proteolysis is particularly preferred during microbial preparation of proteins and/or enzymes, particularly when the compositions also contain proteases. For this use, inventive agents can comprise stabilizers; the supply of these types of agents represents a preferred embodiment of the present invention.

One group of stabilizers are reversible protease inhibitors. For this, benzamidine hydrochloride, borax, boric acids, boronic acids or their salts or esters are frequently used, above all derivatives with aromatic groups, for example ortho, meta or para substituted phenyl boronic acids or the salts or esters. Ovomucoid and leupeptin, inter alia, are mentioned as peptidic protease inhibitors; an additional option is the formation of fusion proteins from proteases and peptide inhibitors.

Further enzyme stabilizers are amino alcohols like mono-, di-, tri-ethanolamine and -propanolamine and their mixtures, aliphatic carboxylic acids up to C₁₂, such as, for example succinic acid, other dicarboxylic acids or salts of the cited acids. End capped alkoxylated fatty acid amides are also suitable. Certain organic acids used as builders can additionally stabilize an included enzyme.

Lower aliphatic alcohols, but above all polyols such as, for example glycerol, ethylene glycol, propylene glycol or sorbitol are further frequently used enzyme stabilizers. Likewise, calcium salts are used, such as for example calcium acetate or calcium formate, and magnesium salts.

Polyamide oligomers or polymeric compounds like lignin, water-soluble vinyl copolymers or cellulose ethers, acrylic polymers and/or polyamides stabilize enzyme preparations against physical influences or pH variations. Polymers that contain polyamine-N-oxide are effective enzyme stabilizers. Other polymeric stabilizers are the linear C₈-C₁₈ polyoxyalkylenes. Alkyl polyglycosides can stabilize the enzymatic components of the inventive agents and even increase their performance. Crosslinked N-containing compounds also act as enzyme stabilizers.

Reducing agents and antioxidants increase the stability of enzymes against oxidative decomposition. A sulfur-containing reducing agent is sodium sulfite, for example.

The use of combinations of stabilizers is preferred, for example of polyols, boric acid and/or borax, the combination of boric acid or borate, reducing salts and succinic acid or other dicarboxylic acids or the combination of boric acid or borate with polyols or polyamino compounds and with reducing salts. The effect of peptide-aldehyde stabilizers is increased by the combination with boric acid and/or boric acid derivatives and polyols and still more by the additional effect of divalent cations, such as for example calcium ions.

Preferably, one or a plurality of enzymes and/or enzyme preparations, preferably solid protease preparations and/or amylase preparations are incorporated in quantities from 0.1 to 5 wt. %, preferably from 0.2 to 4.5 wt. % and in particular from 0.4 to 4 wt. %, each based on the total enzyme-containing agent.

Disintegration Aids

In order to facilitate the disintegration of the preconditioned molded bodies, disintegration aids, so-called tablet disintegrators, may be incorporated in the agents to shorten their disintegration times. According to Römpp (9th Edition, Vol. 6, page 4440) and Voigt “Lehrbuch der pharmazeutischen Technologie” (6th Edition, 1987, pages 182-184), tablet disintegrators or disintegration accelerators are auxiliaries, which promote the rapid disintegration of tablets in water or gastric juices and the release of the pharmaceuticals in an absorbable form.

These substances, which are also known as “disintegrators” by virtue of their effect, increase in volume on contact with water so that, firstly, their own volume increases (swelling) and secondly, a pressure can also be generated by the release of gases, causing the tablet to disintegrate into smaller particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives.

The disintegration aids are preferably incorporated in quantities of 0.5 to 10 wt. %, advantageously from 3 to 7 wt. % and especially from 4 to 6 wt. %, each based on the total weight of the agent containing the disintegration aid.

In the context of the present invention, preferred disintegrators that are used are based on cellulose, and therefore the preferred detergent and cleaning agent compositions comprise such a cellulose-based disintegrator in quantities from 0.5 to 10% by weight, advantageously 3 to 7% by weight and especially 4 to 6% by weight. Pure cellulose has the formal empirical composition (C₆H₁₀O₅)ₙ and, formally, is a β-1,4-polyacetal of cellobiose, which, in turn, is made up of two molecules of glucose. Suitable celluloses consist of ca. 500 to 5000 glucose units and, accordingly, have average molecular weights of 50000 to 500 000. In the context of the present invention, cellulose derivatives obtainable from cellulose by polymer-analogous reactions may also be used as cellulose-based disintegrators. These chemically modified celluloses include, for example, products of esterification or etherification reactions in which hydroxy hydrogen atoms have been substituted. However, celluloses in which the hydroxy groups have been replaced by functional groups that are not attached by an oxygen atom may also be used as cellulose derivatives. The group of cellulose derivatives includes, for example, alkali metal celluloses, carboxymethyl cellulose (CMC), cellulose esters and ethers and aminocelluloses. The cellulose derivatives mentioned are preferably not used on their own, but rather in the form of a mixture with cellulose as cellulose-based disintegrators. The content of cellulose derivatives in mixtures such as these is preferably below 50% by weight and more preferably below 20% by weight, based on the cellulose-based disintegrator. A particularly preferred cellulose-based disintegrator is pure cellulose, free from cellulose derivatives.

The cellulose, used as the disintegration aid, is advantageously not added in the form of fine particles, but rather conveyed in a coarser form prior to addition to the premix that will be compressed, for example granulated or compacted. The particle sizes of such disintegrators are mostly above 200 μm, advantageously with 90 wt. % between 300 and 1600 μm and particularly at least 90 wt. % between 400 and 1200 μm. In the context of the present invention, the abovementioned coarser disintegration aids, also described in greater detail in the cited publications, are preferred disintegration aids and are commercially available for example, from the Rettenmaier Company under the trade name Arbocel® TF-30-HG.

Microcrystalline cellulose can be used as a further cellulose-based disintegration aid, or as an ingredient of this component. The microcrystalline cellulose is obtained by the partial hydrolysis of cellulose, under conditions, which only attack and fully dissolve the amorphous regions (ca. 30% of the total cellulosic mass) of the cellulose, leaving the crystalline regions (ca. 70%) intact. Subsequent disaggregation of the microfine cellulose, obtained by hydrolysis, yields microcrystalline celluloses with primary particle sizes of ca. 5 μm and for example, compactable granules with an average particle size of 200 μm.

In the context of the present invention, preferred disintegration aids, advantageously a disintegration aid based on cellulose, preferably in granular, cogranulated or compacted form, are comprised in the disintegration aid-containing agent in quantities of 0.5 to 10 wt. %, advantageously 3 to 7 wt. % and particularly 4 to 6 wt. %, each based on the total weight of the disintegration aid-containing agent.

Moreover, according to the invention, it can be preferred to incorporate additional effervescing systems as the tablet disintegration aids. The gas-evolving effervescent system can consist of a single substance, which liberates a gas on contact with water. Among these compounds, particular mention is made of magnesium peroxide, which liberates oxygen on contact with water. Normally, however, the gas-liberating effervescent system consists of at least two ingredients that react with one another to form gas. Although various possible systems could be used, for example systems releasing nitrogen, oxygen or hydrogen, the effervescent system used in the detergent tablets according to the invention should be selected with both economic and ecological considerations in mind. Preferred effervescent systems consist of alkali metal carbonate and/or -hydrogen carbonate and an acidifying agent capable of releasing carbon dioxide from the alkali metal salts in aqueous solution.

Among the alkali metal carbonates or hydrogen carbonates, the sodium and potassium salts are markedly preferred against the other salts for reasons of cost. Naturally, the relevant pure alkali metal carbonates or hydrogen carbonates need not be used; in fact, mixtures of different carbonates and hydrogen carbonates can be preferred.

In preferred effervescent systems, 2 to 20% by weight, advantageously 3 to 15% by weight and particularly 5 to 10% by weight of an alkali metal carbonate or -hydrogen carbonate are used, and 1 to 15, advantageously 2 to 12 and preferably 3 to 10% by weight of an acidifying agent, each based on the total weight of the agent.

Suitable acidifiers, which liberate carbon dioxide from alkali salts in aqueous solution, are for example, boric acid and alkali metal hydrogen sulfates, alkali metal dihydrogen phosphates and other inorganic salts Preferably, however, organic acidifiers are used, citric acid being the preferred acidifier. However, solid mono-, oligo- and polycarboxylic acids are also particularly suitable. Within this group, citric acid, tartaric acid, succinic acid, malonic acid, adipic acid, maleic acid, fumaric acid, oxalic acid and polyacrylic acid are again preferred. Organic sulfonic acids, such as amidosulfonic acid, may also be used. Sokalan® DCS (trademark of BASF), a mixture of succinic acid (max. 31% by weight), glutaric acid (max. 50% by weight) and adipic acid (max. 33% by weight), is commercially available and may also be used with advantage as an acidifying agent for the purposes of the present invention.

In the context of the present invention, preferred acidifiers in the effervescing system are from the group of organic di-, tri- and oligocarboxylic acids or their mixtures.

Fragrances

Suitable perfume oils or fragrances include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert.-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenylethyl alcohol and terpineol and the hydrocarbons include, above all, the terpenes, such as limonene and pinene. However, mixtures of various odoriferous substances, which together produce an attractive perfume note, are preferably used. Perfume oils such as these may also contain natural perfume mixtures obtainable from vegetal sources, for example pine, citrus, jasmine, patchouli, rose or ylang-ylang oil. Also suitable are muscatel oil, oil of sage, chamomile oil, clove oil, melissa oil, mint oil, cinnamon leaf oil, lime blossom oil, juniper berry oil, vetivert oil, olibanum oil, galbanum oil and ladanum oil and orange blossom oil, neroli oil, orange peel oil and sandalwood oil.

The fragrances may be directly incorporated, although it can also be of advantage to apply the fragrances on carriers that due to a slower fragrance release ensure a long lasting fragrance. Suitable carrier materials are, for example, cyclodextrins, the cyclodextrin/perfume complexes optionally being coated with other auxiliaries.

Colorants

Preferred colorants, which are not difficult for the person skilled in the art to choose, have high storage stability, are not affected by the other ingredients of the agent or by light and do not have any pronounced substantivity for the substrates such as glass, ceramics or plastic dishes being treated with the colorant-containing agent, so as not to color them.

1. Solid dishwasher detergent comprising
a) 1 to 40 wt. % bleaching agent,
b) 0.25 to 20 wt. % non-ionic surfactant(s);
c) 0.01 to 10 wt. % of at least one polymer with a molecular weight of 2000 gmol⁻¹ or greater that possesses at least one positive charge,
wherein the weight ratio of component b) to component c) is between 25:1 and 100:1.

2-17. (canceled)

18. The dishwasher detergent of claim 1 wherein the weight ratio of the component b) to component c) is between 35:1 and 75:1.

19. The dishwasher detergent of claim 1 comprising 1 to 35 wt. % bleaching agent.

20. The dishwasher detergent of claim 1 comprising 5 to 15 wt. % bleaching agent.

21. The dishwasher detergent of claim 1 wherein the bleaching agent is sodium percarbonate.

22. The dishwasher detergent of claim 1 comprising 0.5 to 15 wt. % of one or more non-ionic surfactants.

23. The dishwasher detergent of claim 1 comprising 2 to 8 wt. % of one or more non-ionic surfactants.

24. The dishwasher detergent of claim 1 comprising one or more non-ionic surfactants of the general formula
R¹O[CH₂CH(CH₃)O]ₓ[CH₂CH₂O]_{y}CH₂CH(OH)R²
in which R¹ stands for a linear or branched aliphatic hydrocarbon group with 4 to 18 carbon atoms or mixtures thereof, R² stands for a linear or branched hydrocarbon group with 2 to 26 carbon atoms or mixtures thereof, and x stands for values between 0.5 and 1.5 and y stands for a value of at least 15.

25. The dishwasher detergent of claim 1 comprising one or more non-ionic surfactants of the general formula 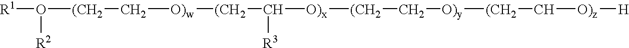
in which R¹ stands for a linear or branched, saturated or mono- or polyunsaturated C₆₋₂₄-alkyl or alkenyl group, each group R² or R³ independently of one another is selected from —CH₃, —CH₂CH₃, —CH₂CH₂—CH₃, CH(CH₃)₂, and the indices w, x, y, z independently of one another stand for whole numbers from 1 to 6.

26. The dishwasher detergent of claim 1 comprising one or more non-ionic surfactants of the general formula
R¹O[CH₂CH(R³)O]ₓR²
in which R¹ stands for linear or branched, saturated or unsaturated, aliphatic or aromatic hydrocarbon groups with 1 to 30 carbon atoms, R² stands for linear or branched, saturated or unsaturated, aliphatic or aromatic hydrocarbon groups with 1 to 30 carbon atoms, R³ stands for H or a methyl, ethyl, n-propyl, isopropyl, n-butyl, 2-butyl or 2-methyl-2-butyl group, and x has a value between 1 and 40.

27. The general formula of claim 9 wherein either or both R¹ and R² contain 1 to 5 hydroxyl groups.

28. The general formula of claim 10 wherein either or both R¹ and R² are functionalized with an ether group,

29. The dishwasher detergent of claim 1 comprising one or more non-ionic surfactants of the general formula
R¹O[CH₂CH₂O]ₓCH₂CH(OH)R²
which, in addition to a group R¹ that stands for linear or branched, saturated or unsaturated, aliphatic or aromatic hydrocarbon groups with 1 to 30 carbon atoms, additionally comprises a linear or branched, saturated or unsaturated, aliphatic or aromatic hydrocarbon group with 1 to 30 carbon atoms R² that is neighboring a monohydroxylated intermediate group —CH₂CH(OH)— and in which x stands for a number between 1 and 40.

30. The dishwasher detergent of claim 1 comprising one or more non-ionic surfactants of the general formula 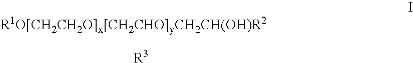
in which R¹ and R² independently of one another stand for linear or branched, saturated or mono- or polyunsaturated hydrocarbon groups with 2 to 26 carbon atoms, R³ is selected from —CH₃; —CH₂CH₃, —CH₂CH₂—CH₃, CH(CH₃)₂, and x and y independently stand for values between 1 and 32.

31. The general formula of claim 14 wherein the values for x are from 15 to 32 and for y are from 0.5 and 1.5.

32. The dishwasher detergent of claim 1 present in the form of a preconditioned unit dose comprising between 0.5 and 4 g non-ionic surfactant.

33. The dishwasher detergent of claim 1 present in the form of a preconditioned unit dose comprising between 1.5 and 2.5 g non-ionic surfactant.

34. The dishwasher detergent of claim 1 present in the form of a preconditioned unit dose, wherein said preconditioned unit dose comprises a molded body.

35. The molded body of claim 17 wherein the molded body is a multiphase molded body,

36. The molded body of claim 17 wherein the molded body is a mono- or multiphase tablet with a filled cavity.

37. The dishwasher detergent of claim 1 present in the form of a preconditioned unit dose, wherein said preconditioned unit dose is selected from the group consisting of a filled water-soluble container, a filled injection molded body, a filled cast body and a filled film pouch.

38. The dishwasher detergent of claim 1 comprising 0.02 to 7.5 wt. % of at least one polymer with a molecular weight of 2000 gmol⁻¹ or above that possesses at least one positive charge.

39. The dishwasher detergent of claim 1 comprising 0.1 to 1 wt. % of at least one polymer with a molecular weight of 2000 gmol⁻¹ or above that possesses at least one positive charge.

40. The dishwasher detergent of claim 1 wherein the polymer c) possesses monomer units of the formula R¹R²C═CR³R⁴, in which each group R¹, R², R³, R⁴ independently is selected from hydrogen, derivatized hydroxyl groups, C1 to C30 linear or branched alkyl groups, aryl, aryl substituted C1-30 linear or branched alkyl groups, polyalkoxylated alkyl groups, heteroatomic organic groups having at least one positive charge without charged nitrogen, at least one quaternized nitrogen atom or at least one amino group with a positive charge in the pH range 2 to 11, or salts thereof, with the proviso that at least one group R¹, R², R³, R⁴ is a heteroatomic organic group with at least one positive charge without charged nitrogen, at least one quaternized nitrogen atom or at least one amino group with a positive charge.

41. The dishwasher detergent of claim 1 wherein the polymer c) comprises at least one of diallyldimethylammonium salts or acrylamidopropyltrimethylammonium salts as monomer units.

42. The dishwasher detergent of claim 1 wherein the proportion by weight of the component b) to the component c) is between 25:1 and 100:1.

43. The dishwasher detergent of claim 1 wherein the proportion by weight of the component b) to the component c) is between 35:1 and 70:1.

44. The dishwasher detergent of claim 1 comprising 10 to 80 wt. % of one or more water-soluble builders.

45. The dishwasher detergent of claim 1 comprising 25 to 65 wt. % of one or more water-soluble builders.

46. A method of cleaning glassware comprising contacting the glassware with the dishwasher detergent of claim 1, then rinsing the glassware.
